(19) United States
(12) Patent Application Publication
(10) Pub. No.: US 2025/0078190 A1
(43) Pub. Date: Mar. 6, 2025

(54) TOKENIZED ASSET OWNERSHIP AND TRANSFERENCE

(71) Applicant: EL-DAR AL-KHASSEH LTITWER AL-OMRANI Ltd., Jeddah (SA)

(72) Inventors: Essam Fakieh, Jeddah (SA); Ahmed A. Fadol, Washington, DC (US)

(21) Appl. No.: 18/809,237

(22) Filed: Aug. 19, 2024

Related U.S. Application Data
(60) Provisional application No. 63/535,925, filed on Aug. 31, 2023.

(51) Int. Cl. G06Q 50/16

(52) U.S. Cl. CPC G06Q 50/167

(57) ABSTRACT

Described is a system for fractional ownership of physical properties using virtual asset units by receiving a digital physical property title for a physical property from an owner, identifying a value of the physical property, generating a plurality of virtual asset units corresponding to the value, and transmitting the generated virtual asset units to a virtual asset storage associated with the owner. The system periodically, during a utilization period: receives an indication of a virtual asset relocation from the physical property user utilizing the physical property, identifying a first portion of the virtual asset relocation transmitted to the owner, determining virtual asset units corresponding to a second portion of the virtual asset relocation, and transferring the number of virtual asset units corresponding to the second portion from the virtual asset storage of the physical property owner to a virtual asset storage of the physical property user.

This patent application claims the benefit of U.S. Provisional Patent Application No. 63/535,925, filed Aug. 31, 2023, entitled “Tokenizing Asset Ownership and Transference”, which is incorporated by reference herein in its entirety.

### TECHNICAL FIELD

The present disclosure relates generally to a tokenization system, and more specifically to an asset-backed tokenization system for progressive asset ownership.

### BACKGROUND

Traditional home ownership often involves acquiring a mortgage from a financial institution like a bank or a mortgage lender. In this setup, an aspiring homeowner, upon finding a suitable property, applies for a mortgage loan. The lender evaluates the applicant's creditworthiness based on their financial history, current income, and debt levels, among other factors. If the application is approved, the lender provides the funds necessary to purchase the home, and the homebuyer agrees to repay the loan over a predefined period, typically in monthly installments over 15 to 30 years. The property serves as collateral, which means that if the borrower fails to make the required payments, the lender has the right to take possession of the home (foreclosure) and sell it to recover their funds. Over time, as the homebuyer makes their mortgage payments, they gradually build equity in the home, which represents their financial stake or ownership interest in the property. When the loan is fully repaid, the lender releases the lien to the deed, indicating full ownership to the home buyer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an architecture for tokenizing of a real estate asset, according to some examples.

FIG. 2 illustrates an architecture comparing conventional mortgage and rental systems with the tokenization system regarding ownership of the property over time, according to some examples.

FIG. 3 illustrates an architectural diagram between the tokenization system, asset owners, and individuals, according to some examples.

FIG. 4 illustrates an example method for progressive ownership through asset utilization using the tokenization system, according to some examples.

FIG. 5 illustrates an architectural diagram of progressive ownership, according to some examples.

FIG. 6 illustrates examples of various different ways a physical asset changes value, according to some examples.

FIG. 7 illustrates an example architecture for the right of use and ownership of an asset, according to some examples.

FIG. 8 illustrates an example architecture for the right of use and ownership of two properties, according to some examples.

FIG. 9 illustrates ownership transfer for a collection of physical commodities, according to some examples.

FIG. 10 illustrates the application of machine learning models to features of the tokenization system, according to some examples.

FIG. 11 illustrates fungible usage rights, according to some examples.

FIG. 12 illustrates an example of a multi-user multi-asset-slot scenario with tokenized real world assets, according to some examples.

FIG. 13 illustrates virtual reality changes enabling usage rights to real world assets, according to some examples.

FIG. 14 illustrates examples of value extractions for a property occupant with progressive ownership, according to some examples.

FIG. 15 illustrates an intermediary submitting tokens for use of a home, according to some examples.

FIG. 16 illustrates a first mode for a conventional loan, according to some examples.

FIG. 17 illustrates a second mode for another loan without collateral, according to some examples.

FIG. 18 illustrates a third mode regarding collateral for a loan, according to some examples.

FIG. 19 illustrates a third mode illustrating token relocation based on appreciation in value of the property, according to some examples.

FIG. 20 illustrates a forth mode illustrating token relocation based on a sudden change in value of the property, according to some examples.

FIG. 21 is a diagrammatic representation of a machine in the form of a computer system within which a set of instructions may be executed to cause the machine to perform any one or more of the methodologies discussed herein, according to some examples.

FIG. 22 is a block diagram showing a software architecture within which examples may be implemented.

FIG. 23 illustrates a machine-learning pipeline, according to some examples.

FIG. 24 illustrates training and use of a machine-learning program, according to some examples.

FIG. 25 illustrates tokenization of an asset as a whole, according to some examples.

FIG. 26 illustrates tokenization of an asset that is divisible into parts, according to some examples.

FIG. 27 illustrates tokenizing ownership and/or usage across time, according to some examples.

FIG. 28 illustrate tokenizing ownership and/or usage across time and parts, according to some examples.

FIG. 29 illustrates tokenization for use allocations, according to some examples.

FIG. 30 illustrates token generation based on location, according to some examples.

FIG. 31 illustrates token generation for copies of goods, according to some examples.

### DETAILED DESCRIPTION

Traditional systems come with several limitations and challenges. Traditional mortgage systems are rigid and cannot easily adjust to the changing financial circumstances of homeowners. If homeowners encounter financial difficulties, they are at risk of defaulting on their mortgage payments, leading to foreclosure and loss of their investment. Moreover, there is no existing technology in traditional systems that enables renters to own equity for a future home. The home owners need to pay a large down payment, generally about 20%, and take a loan for the remainder amount, requiring a lot of upfront cost and prolonged risk for the term of the loan.

Moreover, real estate, in its traditional form, is an illiquid asset. This means it can take a considerable amount of time to buy a property or to sell a property to convert it into cash. This lack of liquidity can be a significant issue for homeowners who need to access the value of their property quickly.

Traditional real estate transactions involve many intermediary systems, which can lead to delays, inefficiencies, and high transaction costs. Real estate transactions require a significant amount of paperwork, from the initial purchase agreement to the final closing documents. This can be a slow and inefficient process, prone to human error.

Even after all terms are agreed upon and the mortgage is approved, the process of transferring funds, paying all related fees, and finalizing the transaction (known as “closing”) can be complex and time-consuming. It requires a high level of coordination among multiple parties, and any missteps can result in significant delays. Moreover, costs throughout the process can include realtor fees, closing costs, notary fees, and other administrative charges, which can make the process of buying or selling a home expensive.

Traditional real estate transactions can be opaque and complex, which can lead to potential fraudulent activities. Issues such as double spending, selling disputed properties, or fraudulent alterations to property deeds are risks in the traditional system, creating uncertainty and mistrust.

Examples of the example tokenization system as described herein mitigate and/or eliminate the pitfalls of traditional systems as described above. The example tokenization system presented here introduces an innovative way of real estate ownership through tokenization.

The tokenization system divides a physical asset, such as a property, into digital tokens that represent ownership of a fraction of the underlying asset. This approach to property ownership uses the principles of tokenization (such as a distributed ledger or blockchain technology) to divide the asset's value into equally valued tokens, and a number of a certain amount of tokens equal the value of the asset.

The tokenization system evaluates the asset owner's property and receives the deed from the asset owner. The tokenization system then generates (or mints) a specific number of tokens equivalent to the property's value. These tokens represent a digital version of property ownership and can be bought, sold, or traded, much like traditional property rights but with the added technical advantages of digital assets, as will be further described herein.

The tokenization system introduces a new technological paradigm of renting and ownership. A tenant can rent the home, and instead of merely paying rent, the tenant also has an option to gradually purchase tokens from the asset owner over a period of time. Over time, the tenant could potentially acquire all the necessary tokens, and in doing so, effectively become the homeowner. At this point, the tokenization system transfers ownership of the property to the tenant (e.g., by transferring over the deed, recording ownership of the property to a regulatory authority, etc.). In some cases, the corresponding tokens for the property are purged from the system.

The tokenization system also accounts for different scenarios. If a tenant decides not to renew his or her lease before owning all tokens, the tokenization system allows the asset owner to repurchase the tokens. In some cases, the tenant can resell their owned tokens on the open market, converting their token equity back into a liquid asset. Alternatively, the tokenization system enables transfer of tokens to another property by releasing the deed to the first property owner, and begins the technological steps for tokenization for the next property. For example, the tokens purchased by the tenant during the term of their lease can be applied as equity to the second property, such that the new tenant would only have to obtain the remaining amount of equity to own the new home.

In essence, the tenant is able to carry fungible equity via these tokens. They can manage their investment fluidly, leveraging the benefits of tokenization to bring flexibility and accessibility to real estate ownership. This system revolutionizes the housing market by introducing a practical, technology-centric solution to many of the issues plaguing the traditional path to homeownership.

The tokenization system addresses the limitations and challenges in traditional systems using the features described herein. By allowing tenants to gradually earn equity in a property through the acquisition of tokens, the tokenization system introduces a more flexible model of homeownership. The risk of foreclosure is mitigated, as tenants provide liquidity by reselling their tokens in case of financial difficulties.

The tokenization system eliminates the need for a large upfront down payment, as is required in traditional mortgage systems. Tenants gradually accrue ownership of the property through purchases of tokens, making the path to homeownership less financially burdensome.

The issue of illiquidity associated with traditional real estate is resolved through the tokenization of property. Tenants can quickly sell their tokens on the open market if they need to access the value of their property quickly.

The tokenization system eliminates the need for multiple intermediaries involved in traditional real estate transactions. This reduces delays and inefficiencies, and lowers transaction costs as token transactions are less expensive than traditional real estate transactions.

By leveraging tokenization (such as distributed ledger and blockchain technology), the tokenization system ensures transparency and reduces the potential for fraudulent activities. All token transactions are immutable and publicly visible on the blockchain, thereby reducing the risk of fraudulent alterations to property deeds.

In essence, by enabling tenants to gradually earn equity in a property, making real estate a more liquid asset, increasing efficiency and lowering transaction costs, and ensuring transparency, the tokenization system presents a novel and superior approach to property ownership, bringing increased transparency, flexibility, and efficiency to the real estate market using the technology of tokenization.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in the tokenization process. Computing resources used by one or more machines, databases, or networks may thus be more efficiently utilized or even reduced.

### Tokenization of Asset

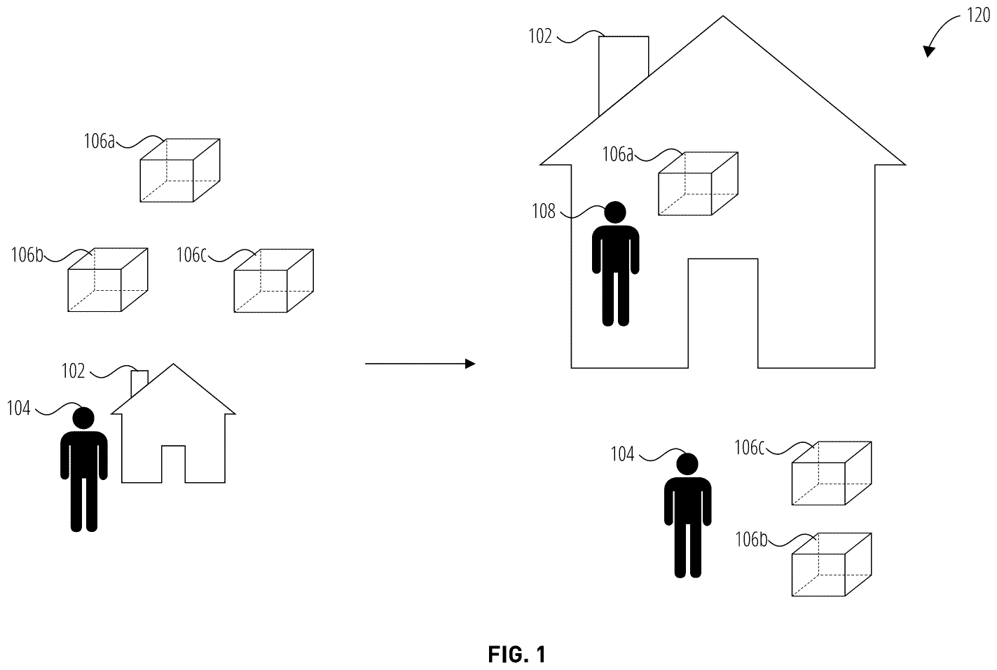

FIG. 1 illustrates an architecture 120 for tokenizing of a real estate asset, according to some examples. The process of tokenizing a home or an asset by the tokenization system can be described into several steps.

One step is for the tokenization system to evaluate the property to determine its current market value. In some cases, the tokenization system employs technological methods for estimating the value of a property. In some cases, the tokenization system compares the property to similar properties in the same area that have been sold recently by retrieving data from third party real estate databases.

In some cases, the tokenization system applies a regression analysis that can determine how different variables (like location, size, age, number of rooms, and nearby amenities) impact the property's value. The algorithm is trained on a vast dataset of property sales to learn the weight of each variable.

In some cases, the tokenization system applies Geographic Information System (GIS) data, which includes geographical and topological data about a property and its surroundings. The tokenization system applies this data to assess the value based on physical features like proximity to water bodies, hills, parks, and more.

In some cases, the tokenization system applies one or more artificial neural networks to predict property values. The neural network is trained on a large dataset and can handle complex, non-linear relationships between variables (such as data related to the property and other similar assets), making the estimate more accurate.

Although artificial intelligence, neural networks, and machine learning models are disclosed as performing certain features, it is appreciated that a machine learning model can be trained and applied by the tokenization system to perform any or all of the features of the tokenization system as described herein. For example, a first machine learning model facilitates decisioning by the tokenization system between modules and other machine learning models, whereas a second machine learning model generates a prediction of property values.

Systems and methods described herein include training a machine learning network, such as training to generate smart contracts, predict property values, mint tokens, facilitate transactions to various individuals and wallets, perform features on deeds and ownership, and/or the like. The machine learning network can be trained to perform one or more of the features for the tokenization system as described herein.

The machine learning algorithm can be trained using historical information. For example, the machine learning model is trained to generate smart contracts by applying historical real estate transactions for use cases on the tokenization system, resulting in self-executing smart contracts which are deployed on the blockchain (e.g., sent to the blockchain network and stored on the distributed ledger).

Training of models, such as artificial intelligence models, is necessarily rooted in computer technology, and improves modeling technology by using training data to train such models and thereafter applying the models to new inputs to make inferences on the new inputs. Here, the new inputs can be information relating to a new homeowner requesting tokenization of the home to rent and slowly sell the home to a new tenant. The trained machine learning model performs the various features of enabling the homeowner to tokenize the home and enable the new tenant to progressively own the home.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models.

Such training is the framework of machine learning algorithms that enable the models to be applied to new and unseen data (such as new tenant or asset owner data) and make predictions that the model was trained for based on the weights or scores that were adjusted during training. Such training of the machine learning models described herein reduces false positives and increases the performance.

Once the property value is established, the homeowner submits a digital version of the deed to the tokenization system. This deed serves as a legal proof of ownership and will be held by the tokenization system for the duration of the rental agreement.

Using the property's evaluated value and a particular value for each token (whether a predefined value or current market value), the tokenization system determines a number of tokens to be minted. For example, if a home 102 of FIG. 1 is valued at $300,000 and each token is worth $100,000, the system mints 3 tokens 106a, 106b, 106c (collectively referred to herein as tokens 106). These tokens are digital representations of ownership in the property.

The tokenization system mints new tokens on the blockchain or distributed ledger by creating new digital tokens or coins. First, the tokenization system generates a smart contract and is deployed to the blockchain. This contract serves as the blueprint for the new tokens and contains rules about how the tokens can be transferred, how many will exist, and other necessary specifications.

Once the smart contract is live, the blockchain invokes the smart contract to mint new tokens. When the mint function is called, a specified number of tokens are created and assigned to the specified owner's address. In this case, an asset owner 104 is assigned as the owner of the tokens 106 representing full ownership of the home 102. As the minted tokens are then awarded to the homeowner, the tokenization system effectively converts the real-world asset into a digital form of ownership that can be divided, sold, or traded.

Although the examples described herein explain blockchain technology, digital ledger technology, tokens, and/or smart contracts to apply to particular examples, it is appreciated that the features of the tokenization system can be applied to other blockchains, tokens, and/or smart contracts. For example, blockchain technology can be applied to predict property values, and mint tokens, whereas smart contracts can be applied to facilitate a transaction (such as a payment) to various individuals and wallets, perform features on deeds and ownership, and/or the like.

The advent of blockchain technology, tokenization, and/or smart contracts improve trusts in the tokenization system using various features rooted in technology. Blockchain technology ensures that once a transaction is recorded on the blockchain, it can't be changed. In the context of the tokenization system, once the owner receives tokens corresponding to their property's value, that transaction is recorded permanently. The same goes for each token that a tenant purchases. This creates a clear, immutable record of who owns the asset, making the system much more trustworthy.

Moreover, every transaction on the blockchain is visible to all network participants. This means that the process of tokenization, as well as each subsequent token purchase, is completely transparent. No one can secretly change the number of tokens or alter the value of the asset, because such a change would be visible to everyone on the network.

The decentralized nature of blockchain also contributes to its trustworthiness. Rather than relying on a single entity (like a bank or government) to verify transactions, blockchain uses a network of nodes (computers). Each node has a copy of the blockchain, and transactions are verified through a consensus process. In essence, multiple parties agree on the validity of transactions, making it virtually impossible for fraudulent activity to occur.

The tokenization system can use smart contracts to facilitate one or more processes of the tokenization system. The tokenization system writes (or a machine learning model automatically generates) smart contracts to automatically perform features of the tokenization system as described herein, such as transferring tokens from the tenant to the owner upon receipt of a transaction (such as a payment), and transferring ownership of the asset once all tokens have been purchased. Smart contracts execute automatically when certain conditions are met, and because they're also stored on the blockchain, they're transparent, immutable, and verifiable.

Tokenization of asset ownership, such as in the case of real estate, provides enhanced security and privacy in several ways. With the blockchain or similar decentralized technology that underlies tokenization, there's no central authority holding all the data. This makes it harder for cybercriminals to exploit a single point of failure.

Moreover, once a transaction is recorded and confirmed on the blockchain, it can't be altered or tampered with. This prevents any fraudulent changes to the ownership records. Every token can be tracked from its inception, offering a clear and indisputable lineage of ownership.

Blockchain uses strong cryptographic algorithms to ensure the data in the blockchain can only be read by those involved in the transaction. This means personal and financial data can be securely stored and transferred. The tokenization system applies cryptography to tokenize real estate or any asset on a blockchain. In some cases, the tokenization system applies a public-key (asymmetric) cryptography using pairs of keys: public keys (which may be known to others), and private keys (which are known only to the owner).

The generation of such keys depends on cryptographic algorithms based on mathematical problems to produce one-way functions. The owner of the private key can use the key to sign transactions or data, and anyone with the public key can verify the signature. In the context of blockchain tokenization, the ownership of tokens (and therefore the real estate) can be proven by the possession of the private key.

The tokenization system includes a hash function, which given an input, produces a fixed size string of bytes. Every transaction in a blockchain can be hashed and the hash value is stored in the block. Any change in the transaction data would change the hash, which can easily be checked. These hash functions ensure data integrity.

When a token owner wants to transfer their tokens (representing ownership or equity in a real estate property), the token owner can create a transaction and sign it with their private key. This digital signature proves that the transaction was created by the actual owner and was not tampered with. Anyone can verify the signature with the corresponding public key, but they cannot forge the signature without the private key.

In some cases, the tokenization system encrypts sensitive data using the public key which can only be decrypted using the corresponding private key. This means even if someone else gets hold of this encrypted data, they can't read or understand it without the private key.

These cryptographic features and algorithms of the tokenizing system underpin the security, trust, and immutability aspects of the asset-backed tokens that represent equity in the asset. Such use of keys improves data security by restricting unauthorized use, view, and/or recordation of data onto the tokenization system.

These keys are used to authenticate users to data (such as ownership) or transactions (such as a request to tokenize a real world asset) which increases security, prevents unauthorized access by third parties, and enables users of the tokenization system to apply features in an easily implemented way. Moreover, such encryption features are necessarily rooted in computer technology.

With tokenization, personal details can be kept private while still proving ownership. Rather than sharing all of your personal information, a token representing ownership can be transferred while your personal data stays secured.

The tokenization system applies smart contracts which are self-executing contracts embedded with the terms of the agreement directly written into code and/or onto the distributed ledger. The smart contracts permit trusted transactions and agreements to be carried out among disparate parties without the need for a central authority, legal system, or external enforcement mechanism.

Traditional transactions typically involve intermediaries, such as banks or transaction processors, that have access to all transaction data. With blockchain technology, transactions are made directly between parties, which means that sensitive data, such as transaction information, isn't exposed to third-party companies. This reduces the risk of sensitive data being intercepted or misused.

In summary, through the use of blockchain and tokenization, you can create a secure, transparent system for real estate ownership and transactions that minimizes the risk of fraud, protects privacy, and enhances the security of sensitive data.

A tenant 108 rents the property and, in addition to paying rent, begins to purchase tokens from the homeowner. These transactions can be made separately or as part of the rent payment. Over the duration of the lease, the tenant can acquire one or more tokens, such as token 106a, thereby gaining a portion of ownership in the property.

As the tenant begins to acquire tokens, the proceeds or dividends from the property are divided among the token holders based on their percentage of ownership. In the given example, if the tenant 108 has acquired one token 106a, the tenant would receive ⅓ of the proceeds, while the homeowner would receive ⅔. The proceeds to the tenant can be less than ⅓ of the rent as the proceeds can be determined by subtracting expenses from the rent (such as insurance, property tax, property management). The homeowner could get more than ⅔ if the homeowner is the one performing property management.

This technical method of tokenization enables gradual transfer of ownership from the homeowner to the tenant and provides both parties with more flexibility and liquidity than traditional systems. It also allows for a more seamless and efficient real estate transaction process, reducing the need for intermediaries and reducing costs.

The tokenization system uses a combined order of specific procedures that tokenizes real world properties that represent ownership, and these tokens are used in a variety of different and novel ways as described herein. Not only do some examples and features of the tokenization system eliminate the need for intermediaries that are typical in the home purchasing process, the process of the tokenization system is also different than the process for traditional systems.

The tokenization does not simply automate traditional systems and concepts. By leveraging tokenization technology, the tokenization system enables efficiencies and improvements to the real estate world, such as by leasing of ownership and partial ownership, progressive ownership as a tenant using the property, deed recordation and ownership facilitation, other features of the ownership tokens, and/or the like.

### Conventional Mortgage and Rental Compared With Tokenization System Regarding Ownership Over Time

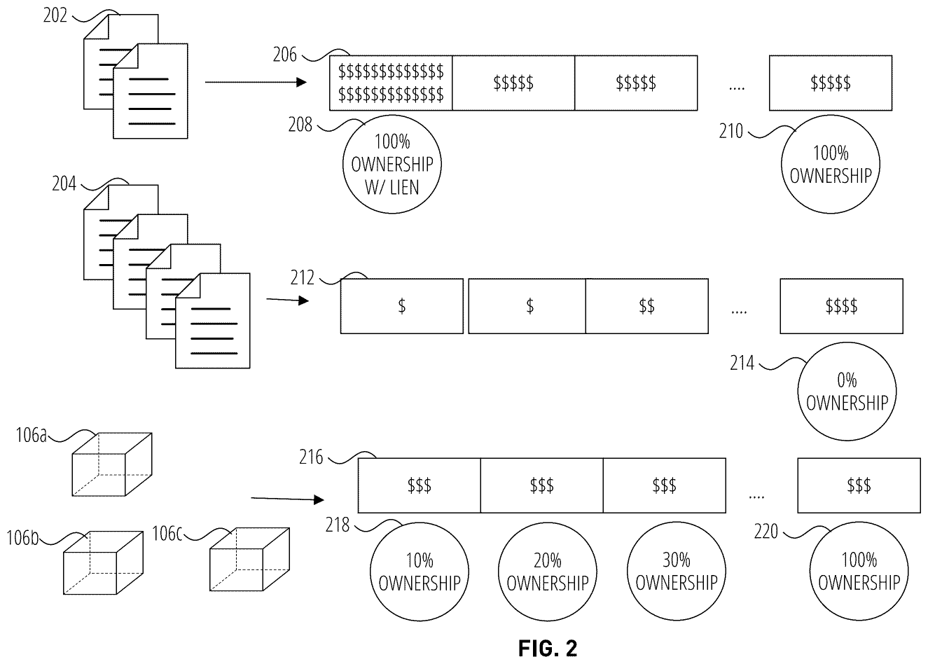

FIG. 2 illustrates an architecture comparing conventional mortgage and rental systems with the tokenization system regarding ownership of the property over time, according to some examples.

In a conventional mortgage system, the homebuyer typically pays a large down payment 206, often 20% of the home's value, and borrows the remaining 80% from a bank or other lending institution. The homebuyer gets legal 100% ownership of the property through a deed, but the lender also has a lien on the property (100% ownership with a lien 208), meaning they can foreclose and take possession if the homebuyer fails to make mortgage payments. The deed 202 is provided to the new buyer.

Integration with land record databases-The system could interface directly with public land records to submit lien documents for recording and retrieve confirmation. In some cases, the tokenization system implements self-executing smart contracts that automatically notifies relevant third party databases that have their own record (such as records of liens and ownerships), transfer lien-related assets, and/or record the lien on the blockchain upon meeting coded conditions.

In some cases, the tokenization system applies IoT sensors, such as sensors on deed documents could track their physical location and confirm when they are processed by the registrar's office. In some cases, the tokenization system applies computer vision algorithms, such as scanning deed documents and verifying registrar stamps and signatures using OCR and image analysis to validate recording (such as lien recording). In some cases, the tokenization system applies web scrapers to scrap public land record sites to check for lien recording and confirm registration details.

In some cases, the tokenization system applies Application Programming Interfaces (API) that interface with registrar's office databases, and submit via API lien data and retrieve recording confirmation of lien recordation programmatically. In some cases, the tokenization records the lien on a distributed ledger, such as recording the lien cryptographically on a blockchain to decentralized ledger.

Over the term of the loan, which could be 15 to 30 years, the homebuyer pays off the borrowed amount along with interest. The interest payments can significantly increase the total amount the homebuyer pays for the home. However, throughout this period, the homebuyer gradually gains equity in the home with each mortgage payment the homebuyer makes, and once the mortgage is fully paid, the homebuyer owns the home outright with 100% ownership 210 without a lien.

When a tenant rents a property, a contract 204 is signed between the tenant and the property owner that includes rental terms. The tenant pays a set amount 212 each month for the use of the property but gains no ownership or equity. Moreover, the rent could increase as time passes. This is typically the least costly option in the short term, as the tenant only pays for the use of the property and don't have to provide a large upfront down payment or pay interest. However, at the end of the lease, the tenant has 0% ownership 214 in the property, and all the money the tenant paid in rent does not contribute to any form of property ownership.

In contrast, the tokenization system combines elements of both mortgages and rentals while leveraging the advantages of tokenization technology. When the tenant uses this tokenization system, the tenant starts renting the property and also purchases tokens 106 over time. Each token represents a fraction of ownership in the property. Each month, the tenant makes payments 216 for the rental of the property and also for the tokens. The tenant gradually builds equity in the property (such as 10% ownership 218 initially) without needing to provide a large down payment upfront or pay high amounts of interest to a lender. Over time, and as leases renew, the tenant accumulates enough tokens to own the property outright at 100% ownership 220 without any liens and risks of default. The tokenization system provides the flexibility to move without the need to sell property, given that the tokens can be sold, transferred, and/or held. The tenant also has the ability to acquire ownership over time, thereby making homeownership more accessible for more people.

### Architectural Diagram Between the Tokenization System, Asset Owners, and Individuals

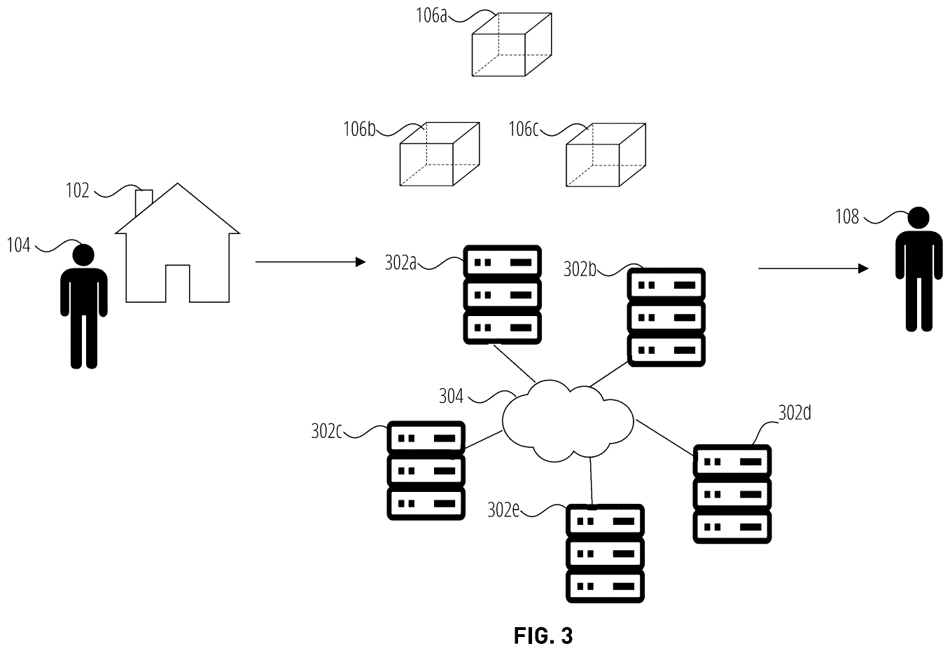

FIG. 3 illustrates an architectural diagram between the tokenization system, asset owners, and individuals, according to some examples. A group of computers 302a, 302b, 302c, 302d, and 302c (collectively referred to as the group of computers 302) connected to the Internet 304 runs the blockchain that forms a decentralized network, also known as nodes in blockchain terminology. These nodes are responsible for maintaining and updating the blockchain ledger, which in this case performs actions that record ownership, transactions, and contractual terms, and execute smart contracts for real estate properties.

When an asset owner 104 wants to tokenize their home 102, the asset owner submits the necessary documentation (such as a deed) to the tokenization system. The tokenization system receives a digital deed and performs functions using one or more forms of artificial intelligence, data processing, and cryptographic technologies.

The tokenization system receives a digital copy of the deed from the asset owner. This digital copy could be a scanned document or a photo of the physical deed. The tokenization system performs Optical Character Recognition (OCR), which can be a form of Artificial Intelligence (AI) that identifies text within digital images or scanned documents. The OCR module converts the visual representation of the text in the digital deed into machine-readable text.

Once the text has been recognized, a Natural Language Processing (NLP) module can be used to identify and extract key pieces of information. NLP, which can be another form of AI, is capable of understanding human language. In this case, the tokenization system identifies information such as the owner's name, the property description, boundaries, and any relevant legal language.

The extracted information is then standardized and stored in a structured database, enabling easy access and comparison. Standardization may involve transforming the text to conform to set formats, such as converting dates to a YYYY-MM-DD format, or geolocating addresses to standardized coordinates. Information, such as a digital copy of a deed, received from the various data sources can be of a different format.

In some cases, the machine learning model classifies the property based on the extracted information. The machine learning model identifies certain characteristics of the property that is not explicitly in the extracted information. For example, the machine learning model classifies a unit as a 1 bedroom based on its size and location.

The tokenization system configures data from multiple different databases that are in their own non-standardized format into a single standardized format. As such, messages can be automatically generated to communicate with individuals such as tenants and asset owners using the standardized format. Moreover, assessments and decisioning made by the tokenization system can be applied back to the asset owner by reapplying non-standardized formatting of the asset owner.

In some cases, the tokenization system processes the deed information into a viewable form, such as in a way which mirrors the physical representation of an original paper form of the deed. This reduces the time consuming nature of importing source code into the form. The tokenization system converts a digital copy of the deed into a standardized form which establishes calculations and rule conditions required to fill in the standardized form, import data from the digital copy to populate data fields in the standardized form, and performs calculations on the imported data. This allows the tokenization system to change imported data into a standardized viewable form.

In some cases, the tokenization system applies such standardization on documents or data received and/or documents generated. The tokenization system generates a standardized form of a deed to enable the tokenization system to generate a viewable deed form. In some cases, the tokenization system generates contracts, such as between the tenant and the asset owner, to rent and purchase tokens. The tokenization system collects data related to the tenant, asset owner, and asset from various different sources and applies standardization to this data to populate fields of the generated documents (e.g., contracts).

In some cases, the machine learning model performs one or more features of the standardization described herein. In some cases, the machine learning model performs customizations and/or standardizations based on a user's preferences. For example, the user inputs preferences such as a particular language for translation, customization on classifications and associated parameters, non-linear transformation, and/or the like.

In some cases, the tokenization system cross-checks information from the deed against a government or public property database. The tokenization system accesses such data via an API (Application Programming Interface) to interface with the relevant public records databases, query the extracted details, and compare the results for verification purposes. This step ensures that the property details match the official records and that the person claiming ownership is indeed the legal owner.

In some cases, the tokenization system and/or machine learning model cross-checks such information from the deed using other third party database. For example, the tokenization system checks information using global positioning system (GPS) data to verify the location, accesses photographs or data of prior owners such as on social media to verify the interior design of the home, and/or assesses a live camera feed from an augmented reality device. For example, the live camera feed can include a walk through of the property and the machine learning model applies computer vision algorithms to the camera feed to identify characteristics of the home, such as door types, bedroom locations, size, and/or the like.

Once the ownership is verified, the tokenization system divides the property's value into multiple tokens, as per the value evaluated by the system or provided by the user. These tokens represent fractional ownership in the property. The token ownership records, deed, and other relevant details are encrypted and stored on a blockchain. Each token transfer can be managed via a smart contract, ensuring that all transactions are secure, transparent, and immutable, and the tokens are made available for tenants to purchase.

In some cases, the tokenization system applies the API to perform a recordation on the property records database, such as a records database of a government entity. In some cases, the tokenization system records a lien on the property based on tokens minted for the property.

In some cases, the tokenization system creates internal property records. For example, the tokenization system uses these internal property records for a layer of protection (e.g., to prevent multiple entries). In some cases, the tokenization system creates an internal property record to not have to rely on public records and/or to rely on such internal records when public records are unavailable.

If the tenant becomes the full owner, the tokenization system facilitates the transfer of ownership. The tokenization system initiates a transaction via the API with the property records database, to record the new ownership, such as via a smart contract indicating full ownership. These operations are conducted securely due to the cryptographic principles of the underlying blockchain and/or tokenization technology.

In some cases, the features related to the deed and/or other features of the tokenization system applies a self-referential table. A self-referential table includes a database table where a foreign key references the primary key of the same table. The tokenization system, for example, applies such self-referential tables to track the ownership history of the tokens representing asset ownership.

Each token could be represented as a row in the table, with fields such as token_id (the primary key), current_owner, previous_owner, and originating_asset (or depositor). The previous_owner field could reference another row in the same table, indicating the previous owner of the token before the current token owner, forming a chain of ownership. Such fields can be recorded onto the digital ledger. The tokenization system uses the originating_asset to associate a token with other tokens minted by the same asset owner. Advantageously, this field helps for certain features of the tokenization system, such as exchangeability and fungibility.

When a token is transferred from one owner to another (e.g., from the asset owner to a tenant), the current_owner field of the token's row is updated with the new owner's ID. A new row is also added to the table, representing a new token owner. The previous_owner field of this new row points to the row representing the token that was just transferred, creating a link in the chain of ownership.

Moreover, the tokenization system tracks a history of ownership via the self-referential table through the previous_owner field. Starting from a row representing a token's current owner, and previous_owner fields that would lead to the previous token owners before the current owner, and so on, until a row is reached where previous_owner is null, indicating the original token issued to the asset owner. This traceability adds to the transparency and security of the system, as it provides a tamper-proof log of token ownership changes.

When tokens are resold back to the asset owner or moved to another property, a similar process to the token transfer can be followed. The current_owner of the affected tokens is updated, and new rows are added to represent the new token owners. In some cases, the tokenization system includes an asset_owner field. The asset_owner field always remains the same asset_owner regardless of whether tokens are told to other individuals, unless the ownership of the asset has been changed.

The self-referential tables can include a special row and/or column within the database that stores the pointers to the other portions of the same table or other tables. Instead of having to save the benefit characteristics for each of the transactions or individuals, the tokenization system includes an entry that refers to another portion of the table or other table with the corresponding information. Advantageously, the data stored in each of the databases can be reduced by calling a call function (e.g. a database pointer) when a certain data entry in another table is needed.

Thus, a tokenization system and/or client devices can perform functions of the tokenization system and have more flexibility in assessing large datasets, which previously required a large network throughput of data and high processing speed. Moreover, a self-referential table can enable more efficient storage and retrieval of larger sized data;; faster searching of the asset ownership, token distribution, and/or the like; and more flexibility in configuring the database.

In some cases, the tokenization system includes the group of computers 302 and/or facilitates communication among the group of computers 302. The nodes in the network validate information, such as ownership, and if validated, the nodes initiate the token creation process. The value of the property is divided by the chosen token value to determine the number of tokens to be minted.

These tokens 106, representing fractional ownership of the property, are issued to the asset owner (such as a tenant 108), such as to the asset owner's digital wallet. The transaction of minting and assigning these tokens is recorded on the ledger.

The nodes (such as the blockchain nodes) also manage the buying, selling, and leasing of tokens. For instance, when a tenant wants to buy tokens from an owner, the tenant submits a transaction to the network. The nodes verify the transaction, make sure the tenant has sufficient funds, and transfer the tokens from the owner's digital wallet to the tenant's. Once the transaction is validated and confirmed by the network (e.g., via the nodes), the transaction is recorded on the blockchain.

If a tenant accrues enough tokens to fully own the property, the blockchain network facilitates the transfer of ownership. The nodes of the blockchain burn or delete the tokens and, update the property's ownership status on the digital ledger. The nodes validate this transaction before recording it on the blockchain. The nodes facilitate transfer over of the deed to the tenant.

When an asset owner (homeowner) decides to tokenize their property, the tokenization system evaluates the property to determine its current market value. The homeowner then provides the system with the necessary documentation (such as a copy of the deed) to confirm ownership of the property.

This information is verified by the decentralized network of computers running the blockchain, such as by accessing real estate records of ownership and/or on its own ledger of real estate ownership records. Once the information has been verified and the property's value has been established, the system will proceed with the tokenization process.

The value of the property is divided by the chosen token value (e.g., if a $300,000 property is divided into tokens each worth $100,000, 3 tokens will be minted as described above). These tokens, representing fractional ownership of the property, are digitally minted on the blockchain and assigned to the homeowner's digital wallet.

If a new tenant moves in or a lease is renewed, the system adjusts the valuation. if the value of the property increases, a certain number of additional tokens are minted and provided to the asset owner and/or the token holders associated with the property.

The homeowner may request to the tokenization system a re-evaluation of the property's value at any point, such as after significant improvements or renovations (e.g., adding a pool). If the value has changed, the system could initiate a re-tokenization process. For instance, if the property's value has increased from $300,000 to $500,000 and the token value remains at $100,000, two additional tokens would be minted and assigned to the homeowner and/or the token holders. This re-tokenization is recorded on the digital ledger.

Tokenizing real estate assets allows for flexibility in buying, selling, and transferring the tokenized assets. Individuals can trade tokens on a peer-to-peer basis on the tokenization platform, which is supported by the blockchain network. If a tenant wishes to buy tokens, they can send a transaction request to another individual who owns the tokens. The nodes verify ownership of the token and payment, and facilitate the transfer of ownership for the token.

The buyer sends the agreed upon amount (often in a form of cryptocurrency or any acceptable payment method on the platform) to the seller. Upon confirmation of payment, a smart contract is executed that transfers the tokens from the seller's digital wallet to the buyer's wallet. This transaction is recorded and verified on the blockchain, providing an immutable record and ensuring transparency.

In some cases, a buyer can buy or sell tokens directly from/to the asset owner. The asset owner lists the tokens for sale on the platform (such as with the specified price). A buyer who wishes to buy these tokens sends a purchase request, pays the specified price, and receives the tokens upon confirmation of payment via a smart contract. The smart contract ensures payment is made and tokens are owned and transferred. The asset owner can also buy back the tokens from the tenant or another token holder using a similar process.

Blockchain technology's inherent transparency, security, and immutability make it well-suited for this kind of application. Each node in the network independently verifies every transaction and maintains a copy of the ledger, making the system highly resilient and reliable. This decentralization also ensures that no single entity has control over the network, increasing trust and participation in the system using technological advances that are not typically used in real estate, let alone real estate ownership scenarios.

Intermediaries such as property developers or token aggregators could hold a pool of tokens from various properties and offer them for sale to interested buyers. The intermediary can list the tokens for sale on the platform, and buyers can purchase these tokens.

Intermediaries also can buy tokens. For instance, a token aggregator might be interested in buying tokens from various individual holders to add to their collection. Individual token holders or asset owners could sell their tokens to these intermediaries following a similar transaction process as described herein.

In these scenarios, the use of smart contracts ensures that transactions are securely executed and recorded. The blockchain's decentralized nature ensures transparency, as all transactions are visible to all participants in the network.

In some cases, the tokenization system and/or a smart contract can facilitate the use of a property. For example, a tenant can be renting a home while obtaining tokens. The tokenization system can facilitate such use by sending a message to control the property. The tokenization system sends a wireless message to a lockbox on the property enabling the user to access keys to open the home. In some cases, such messages can control the use, type of use, availability of certain operations and features, time period and duration of use, and/or the like using these communications.

The tokenization system sends such signals to a computing device or server of the asset, such as a vehicle computing device or a server communicating with one or more smart home systems.

In some cases, depending on the rules set by the platform, tokens are used across properties, meaning a token holder could potentially use their tokens as payment towards rent or purchase in another property on the platform. These features make the tokens of the tokenization system truly fungible and provide additional flexibility to the token holders.

In the context of tokenizing real estate, leasing tokens introduces a level of flexibility and unique opportunities for temporary ownership and use of assets. The tokenization system enables a token holder who owns a certain percentage of an asset to lease tokens to another individual. By doing so, the tokenization system enacts a smart contract that enables the other individual to gain temporary ownership of the tokens and, by extension, the right to use or benefit from a proportion of the asset represented by these tokens.

During the lease period, the tokenization system enables the temporary token holder to rent the property to a tenant. The proceeds from the tenant are received by the tokenization system, whereby smart contracts are invoked to provide the proceeds to the token holder and the temporary token owner. At the end of the lease, the tokenization system invokes a smart contract whereby the tokens are automatically returned to the token owner's wallet.

The distribution of rent proceeds automatically disperse via smart contracts. For instance, if the rent is paid in cryptocurrency, the smart contract automatically distributes the rent to the token owner, the temporary token owner, and property manager based on predefined percentages. For example, the property manager may require a certain amount or percentage of the proceeds.

Token leasing in this manner not only provides opportunities for passive income for token holders but also increases liquidity of the token in the token market. It further allows those without the capital to purchase tokens outright to benefit from tokenized assets temporarily.

Token holders in a real estate tokenization system have various investment strategies at their disposal. The token holders can engage in arbitrage, where they buy and sell tokens to take advantage of price discrepancies across different markets or platforms, turning a profit from the difference in token prices. This might occur if tokens representing the same asset are priced differently in distinct markets.

Token holders can adopt a long-term investment strategy, holding onto tokens to benefit from natural appreciation of the underlying real estate asset. In some cases, over time, as the property value increases, so does the value of each token, providing capital gains to the token holders. In some cases, new tokens are minted and distributed to each owner accordingly, such as if there are multiple owners to a property management company or to multiple properties. Token holders can also deposit or lease their tokens to others, earning a passive income. This approach allows others to use the tokens temporarily, such as for rental income, while the original token holder continues to derive financial benefit.

In some cases, the asset owner divides the value of a single asset (say, a house) into several tokens. Each token represents a proportional stake in the returns from the asset (like rent). The tokenization system enables transfer of property ownership to a token holder who accumulates tokens equivalent to the asset's total value. In such a case (e.g., in response to transfer of the ownership), the tokens corresponding to that asset are removed from circulation or “purged.”

In some cases, the tokenization system enables an asset owner to have several assets (say, multiple properties). Here, the total value of all assets is divided into tokens, each representing a proportional stake in the returns from all assets. Alternatively, each individual asset can also have its own token representation. The tokenization system enables token holders to acquire ownership of an individual asset or a percentage of a group of assets by accumulating tokens equivalent to the asset's total value. In some cases, different owners of the same or different properties can each tokenize their equity and/or ownership.

This kind of tokenized asset ownership provides investors with a new way to diversify their portfolios and potentially lower barriers to entry in markets like real estate using the technological advances of tokenization.

Although examples described herein refer to asset or real estate property, it is appreciated that examples described herein can refer to other types of assets, including both physical and/or intangible assets. For example, assets can refer to vehicles, such as cars, boats, planes, and other vehicles, allowing investors to own a piece of these assets and potentially share in their appreciation over time.

In some cases, the assets refer to artwork and/or collectibles, such as paintings, sculptures, rare collectibles, and other valuable items that can be tokenized to enable broader ownership. This could lower the barriers to entry in the art investment market, which has traditionally been accessible only to the wealthy.

In some cases, assets refer to intellectual property, such as copyrights, patents, and other forms of intellectual property. This could enable creators to raise funds while allowing investors to share in the potential profits from these assets.

In some cases, assets refer to commodities such as gold, oil, or agricultural products, providing another way for investors to gain exposure to these markets. In some cases, assets refer to business equity, allowing investors to buy and sell tokens representing shares in the company. In some cases, assets refer to debt instruments, such as bonds or loans, which could create more flexibility and liquidity in the debt market. In some cases, assets refer to digital assets such as domain names, digital art (such as non-fungible tokens-NFTs), and in-game assets.

### Progressive Ownership Through Asset Utilization

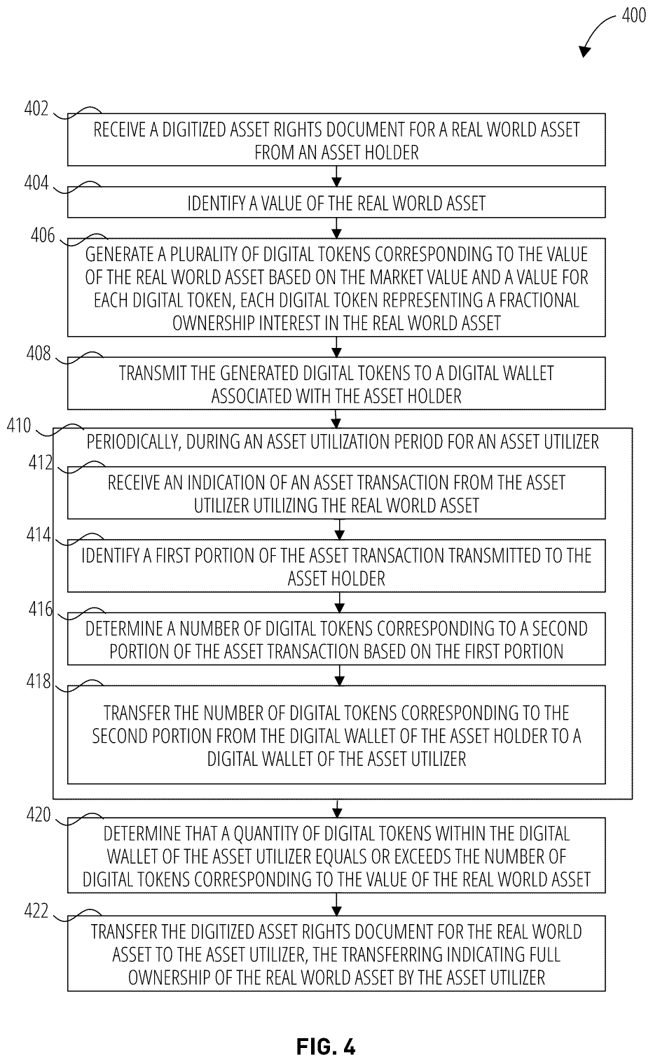

FIG. 4 illustrates an example method 400 for progressive ownership through asset utilization using the tokenization system, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At block 402, the tokenization system receives a digitized asset rights document for a real world asset from an asset holder. The tokenization system acquires a digital representation of the legal rights associated with a tangible asset, provided by the individual or entity that currently holds those rights. The tangible asset can be any form of real-world property, such as real estate, vehicles, artwork, or other valuable goods.

In some cases, the real world asset includes a real estate property, such as a home, a building 506, a car 504, equipment such as recording equipment 508, material such as gold or steel, technology such as a server or radio station, and/or the like. The real world asset can include any real world object that can be tokenized based on its value.

The digitized asset rights document includes a legal document that establishes the ownership and rights associated with the asset. This could be a deed for a property, a title for a vehicle, or any other legal document that establishes ownership.

The process of digitizing this document involves taking a picture or scanning a physical copy of the asset rights document. The tokenization system converts the information within the digitized asset rights document into a digital format that can be stored, transmitted, and processed electronically. In some cases, the tokenization system scans the digitized asset rights document and applies optical character recognition (OCR) to extract text.

The tokenization system can apply a machine learning model to map data fields in the digitized asset rights document to relevant data fields in the tokenization system database. In some cases, the tokenization system standardizes data in the digitized asset ownership document. For example, formats and data can be different across different documents, such as abbreviations, acronyms, and/or formats (e.g., zipcodes). The tokenization system standardizes such data, such as using a machine learning model, in order to store and process the data.

With data in standardized format, the tokenization system can compare data to other data in its database. If the tokenization system desires to send data back to the computing system that transmitted the digitized asset ownership document or other third party databases, the tokenization system converts the data into the non-standardized format of the receiving party.

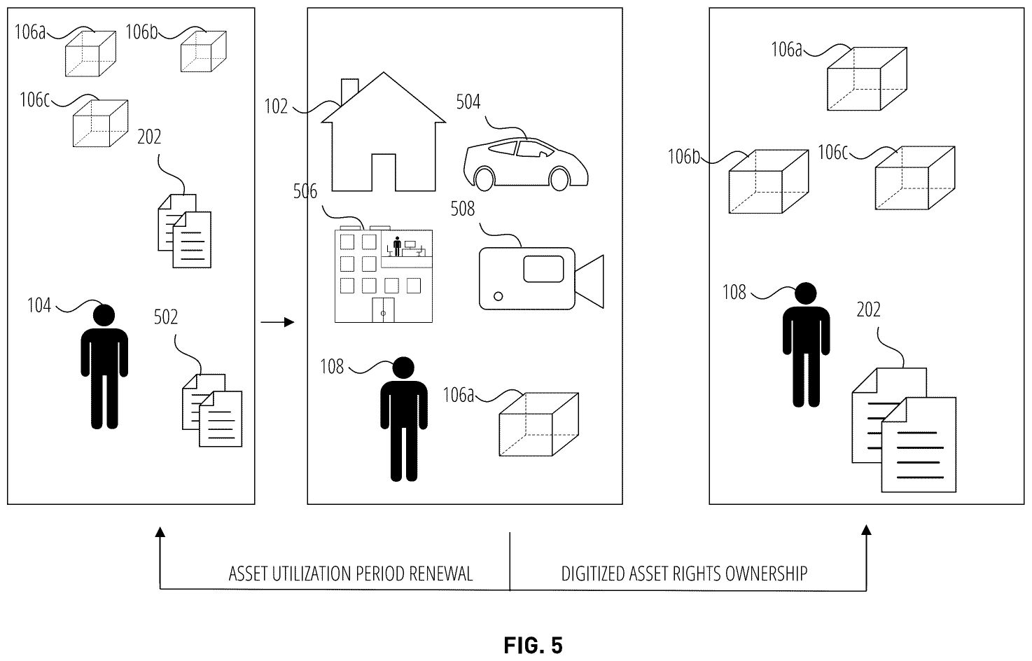

FIG. 5 illustrates an architectural diagram of progressive ownership, according to some examples. The asset owner 104 provides a digitized asset rights document (such as a deed 202) to the tokenization system.

At block 404, the tokenization system identifies a value of the real world asset. The tokenization system determines a monetary worth of the real world asset. The tokenization system determines the value of the asset through one or a variety of ways. In some cases, the tokenization system determines the value of the asset depending on the type of asset. For instance, in the case of real estate, the value could be determined through a professional appraisal system, comparative market analysis, or valuation models.

In some cases, the tokenization system applies a valuation model, such as a machine learning model. The tokenization system inputs one or more characteristics of the home. The tokenization system identifies such characteristics based on information from the digitized asset ownership document and/or third party databases. For example, the tokenization system can retrieve an address from the digitized asset ownership document and retrieve characteristics of the property, such as the number of bedrooms, square footage, and/or the like from third party databases.

In some cases, the tokenization system inputs characteristics of the asset into the model, such as the condition, size, location, address, characteristics of the neighborhood, and other factors. The model is trained to identify similar properties (such as properties in a similar neighborhood that share certain characteristics of the asset) and compares the property to these other similar properties that have recently sold in the same area to determine its estimated market value.

In some cases, the valuation models use mathematical modeling combined with databases of existing properties and transactions to calculate property values. These models can quickly provide an estimate of a property's value based on available data. This value serves as the basis for generating the digital tokens that represent ownership of the asset. This value is also used by the tokenization system, machine learning models, and/or smart contracts in accepting transactions if the value is within an acceptable range of values.

At block 406, the tokenization system generates a plurality of digital tokens corresponding to the value of the real world asset. For example, the tokenization system generates digital tokens based on the market value and a value for each digital token. Each digital token represent a fractional ownership interest in the real world asset.

The tokenization system creates (or mints) digital tokens that represent fractional ownership in the tangible real world asset. These tokens are generated in a quantity that corresponds to the previously determined value of the asset.

The tokenization system identifies a value for each digital token. The tokenization system can set the price of each digital token, the price can be set by a user such as the asset owner, and/or the price can be set by the market (such as based on buy and sell orders on an exchange that exchanges tokens for other monetary value such as money). The token price can be a standard value across all assets, and/or it could vary based on factors such as the type of asset, the total value of the asset, or market conditions.

Once the value per token is identified, the system determines the number of tokens to be generated that corresponds to the value of the asset. For example, the tokenization system divides the total value of the asset by the value of each token. For example, if a property is worth $100,000 and each token is worth $100, the system would generate 1,000 tokens. In another example, 3 tokens are considered equal value to the home, and the tokens 106 of FIG. 5 are generated by the tokenization system.

Each of these tokens represents a fractional ownership interest in the asset. For instance, in the above example, each token would represent a 0.1% ownership interest in the property.

The tokenization system can initiate a distributed ledger and/or blockchain technology to generate the tokens. The tokenization system initiates the blockchain to create unique, non-fungible tokens that can be securely tracked and transferred. Each token is a digital asset that is stored on the blockchain, providing a transparent and immutable record of ownership.

Once generated, these tokens can be bought, sold, or traded, allowing for the fractionalization of ownership in the asset. This enables individuals to invest in expensive assets such as real estate without needing to purchase the entire asset outright or having to make a large down payment and signing onto a mortgage. The tokenization system also provides a mechanism for transferring ownership of the asset over time, as individuals can gradually acquire tokens until they own a majority or the entirety of the tokens associated with the asset.

At block 408, the tokenization system transmits the generated digital tokens to a digital wallet associated with the asset holder. A digital wallet includes a software-based system that securely stores users' digital assets, such as cryptocurrencies and/or asset-backed tokens.

The tokenization system initiates the transmission process once the digital tokens have been generated. The tokenization system initiates a transaction on the blockchain network to move the tokens from the system's wallet (or a temporary holding wallet) to the asset holder's wallet.

The tokenization system initiates the creation of a digital signature using its private key, which is then broadcasted to the blockchain network. The network's nodes validate the transaction, ensuring that the tokenization system has the necessary balance of tokens to perform the transaction and that the digital signature matches the system's public key.

Once validated, the transaction is added to a block of transactions, which is then added to the blockchain. This process ensures the immutability and transparency of the transaction, providing a clear record of the transfer of tokens from the system to the asset holder.

The asset holder's digital wallet will then update to reflect the receipt of the new tokens. The asset holder then manages these tokens within their wallet, including transferring them to other wallets or using them in transactions.

At block 410, the tokenization system performs certain steps periodically, during an asset utilization period for an asset utilizer, such as blocks 412, 414, 416, and/or 418. At block 412, the tokenization system receives an indication of an asset transaction from the asset utilizer utilizing the real world asset at block 412.

The tokenization system periodically receives signals or notifications of asset transactions from the asset utilizer during a specified period of asset utilization. The asset utilizer could be a tenant, a renter, or any other party who is using the real-world asset but does not fully own it.

The tokenization system can receive asset transactions that can relate to one or more different actions related to the use or partial acquisition of the asset. For instance, the tokenization system receives an indication of a rent payment, a purchase of additional tokens representing ownership in the asset, or the like. In some cases, the tokenization system determines such payment is made from a third party financial database or server. In other cases, the payment is made directly to the tokenization system.

The tokenization system receives the indication of the asset transaction via digital signal or message sent from the asset utilizer's digital wallet or account to the system. The indication includes information about the transaction, such as the amount paid, the number of tokens purchased, and the time of the transaction.

The tokenization system receives this indication and processes it to update the records of the asset and the associated tokens. The tokenization system updates the balance of tokens in the asset utilizer's digital wallet, updating the remaining value of the asset, and/or updating the record of payments made by the asset utilizer.

At block 414, the tokenization system identifies a first portion of the asset transaction transmitted to the asset holder. This first portion could represent a variety of things depending on the specifics of the transaction and the terms of the asset utilization. For instance, in a rental scenario, the first portion represents the part of the tenant's payment that is allocated towards rent, while the remainder could be allocated towards other costs, such as the purchase of tokens.

The tokenization system transmits the first portion of the asset transaction to the asset holder. In some cases, tokenization system identifies a payment made through other channels, such as assessing a financial transaction from the asset utilizer to the asset holder.

The tokenization system identifies this first portion by analyzing the details of the transaction indication received from the asset utilizer. This could involve parsing the transaction data, applying predefined rules or algorithms, or using machine learning models to classify and quantify the different parts of the transaction.

Once the first portion is identified, the payment is recorded in the system and used to update the records of the asset and the associated tokens. This involves subtracting the value of the first portion from the asset transaction.

At block 416, the tokenization system determines a number of digital tokens corresponding to a second portion of the asset transaction based on the first portion. The second portion of the asset transaction can represent the part of the payment that is allocated towards the purchase of tokens, which represent fractional ownership in the asset. In contrast, the first portion, as identified in the previous step, can represent the part of the payment that is allocated towards other costs, such as rent or to the property manager.

In some examples, a portion of the asset transaction is sent to the property manager. If the asset owner is the property manager, the tokenization system sends the portion of the asset transaction for rent and for property management to the asset owner. If the property manager is a third party, the tokenization system sends separate payments to the property manager and to the asset owner.

The tokenization system determines the number of tokens corresponding to the second portion by dividing the value of the second portion by the value of each token. For example, if the second portion of the payment is $2300 and each token is worth $100, the system would determine that the second portion corresponds to 10 tokens.

At block 418, the tokenization system transfers the number of digital tokens corresponding to the second portion from the digital wallet of the asset holder to a digital wallet of the asset utilizer. The tokenization system facilitates the transfer of a specific number of digital tokens from the digital wallet of the asset holder to the digital wallet of the asset utilizer, such as token 106a to the tenant 108.

In some cases, the transfer process begins with the tokenization system initiating a transaction on the blockchain network. This transaction involves moving the specified number of tokens from the asset holder's wallet to the asset utilizer's wallet.

The tokenization system creates a digital signature for the transaction using the private key associated with the asset holder's wallet. This signature is then broadcasted to the blockchain network, where it is validated by the network's nodes. The nodes check that the asset holder's wallet has a sufficient balance of tokens and that the digital signature matches the public key associated with the wallet.

Once validated, the transaction is added to a block of transactions, which is then added to the blockchain. This process ensures the immutability and transparency of the transaction, providing a clear record of the transfer of tokens from the asset holder to the asset utilizer.

In some cases, in response to a lapse of the asset utilization period for the asset utilizer, the tokenization system determines whether the quantity of digital tokens within the digital wallet of the asset utilizer equals or exceeds the number of digital tokens corresponding to the value of the real world asset. In response to determining that the quantity of digital tokens within the digital wallet of the asset utilizer does not equal or exceed the number of digital tokens corresponding to the value of the real world asset, the tokenization system renews the asset utilization period.

In some cases, the tokenization system automatically renews the asset utilization period. In other cases, the tokenization system generates a new contract to be agreed upon between the asset owner and the tenant for a new asset utilization period.

The asset utilization period can include a predefined time period, such as a lease term or a use term, during which the asset utilizer is expected to acquire full or partial usage rights, and full and/or partial ownership of the asset by purchasing tokens.

The tokenization system retrieves the current balance of tokens in the asset utilizer's digital wallet and compares it to the total number of tokens that correspond to the full value of the real-world asset.

If the system determines that the balance of tokens in the asset utilizer's wallet does not equal or exceed the total number of tokens, the tokenization system determines that the asset utilizer has not yet acquired full ownership of the asset. In this case, the tokenization system renews the asset utilization period, allowing the asset utilizer more time to acquire the remaining tokens.

The renewal of the asset utilization period involves extending the lease term, renewing the loan term, and/or setting a new deadline for the asset utilizer to acquire full ownership. This provides flexibility for the asset utilizer and allows them to continue using the asset and acquiring tokens towards full ownership.

At block 420, the tokenization system determines that a quantity of digital tokens within the digital wallet of the asset utilizer equals or exceeds the number of digital tokens corresponding to the value of the real world asset. For example, the tenant 108 has acquired all tokens, tokens 106a, 106b, and 106c for the home 102.

The tokenization system checks the balance of digital tokens in the asset utilizer's digital wallet and compares the amount to the total number of tokens that correspond to the full value of the real-world asset.

The tokenization system retrieves the current balance of tokens in the asset utilizer's digital wallet. In the case where a distributed ledger is used, the tokenization system queries the blockchain network for the wallet's address and retrieving the associated balance. The tokenization system compares this balance to the total number of tokens that were initially generated to represent the full value of the asset.

In some cases, the tokenization system reassesses a total number of tokens based on the current price of the asset. For example, the asset appreciates (or depreciates) naturally over time. In some cases, modifications or damage occurs to the asset over time, and thus the value appreciates or depreciates.

If the balance of tokens in the asset utilizer's wallet equals or exceeds the total number of tokens, the tokenization system determines that the asset utilizer has acquired full ownership of the asset. This could be the result of the asset utilizer gradually purchasing tokens over time, or of one or more large transactions in which the asset utilizer purchases some or all of the required tokens.

In some cases, the full ownership occurs automatically when balance of tokens in the asset utilizer's wallet equals or exceeds the total number of tokens. In some cases, the asset utilizer is provided the option to acquire the asset upon reaching the required number of tokens.

At block 422, the tokenization system transfers the digitized asset rights document for the real world asset to the asset utilizer, such as the deed 202 in FIG. 5. The transferring indicates full ownership of the real world asset by the asset utilizer.

This transfer is triggered when the tokenization system determines that the quantity of digital tokens in the asset utilizer's digital wallet equals or exceeds the total number of tokens corresponding to the full value of the asset, indicating that the asset utilizer has acquired full ownership.

The digitized asset rights document includes a digital version of a deed, title, or other legal document that establishes ownership of the asset. This document is stored in a secure, tamper-proof format of the tokenization system, such as a blockchain or a secure database.

The tokenization system initiates the transfer by creating a transaction on the blockchain or updating the database to reflect the change in ownership. The tokenization system can change the owner field in the asset rights document to the identifier of the asset utilizer, or creating a new asset rights document with the asset utilizer as the owner and invalidating the previous document.

The tokenization system initiates broadcasting of the transaction or update to the network or commits the change to the database, where it is validated and recorded. This process ensures the immutability and transparency of the ownership transfer, providing a clear and indisputable record of the asset utilizer's ownership.

Once the transfer is complete, the asset utilizer has full legal ownership of the asset, as represented by the digitized asset rights document. The asset utilizer becomes the new asset owner and can exercise all rights and privileges associated with ownership, such as selling the asset, using it as collateral, or making modifications to the asset.

### Changing in Value

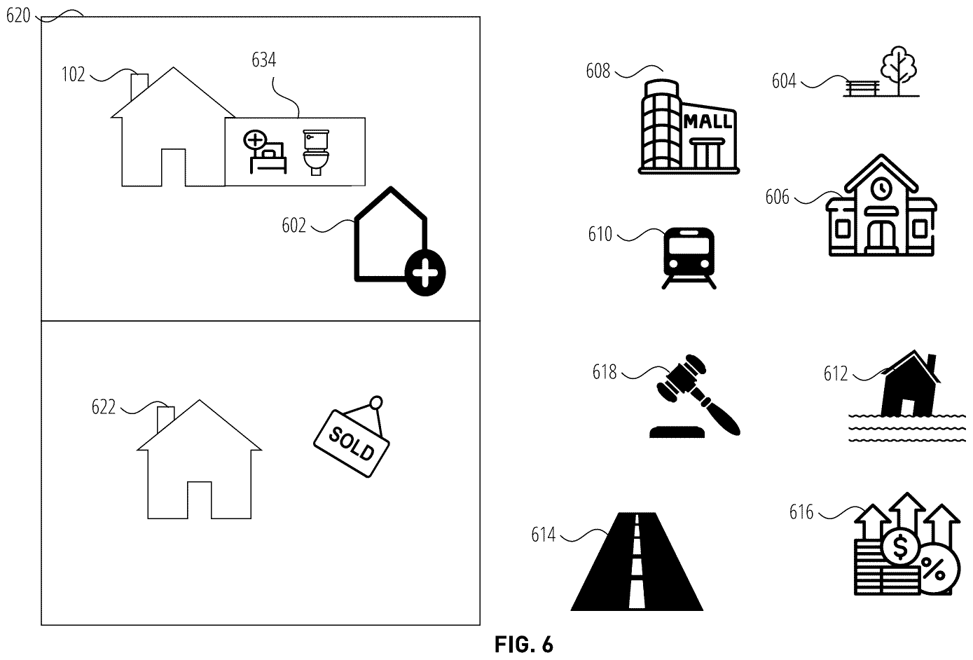

FIG. 6 illustrates examples of various different ways a physical asset changes value, according to some examples. In some cases, the tokenization system identifies a change in value based on a structural change. For example, the home 102 can be on a plot of land 620. The plot of land can increase in size. The home 102 can be renovated to add more living space such as a new bedroom 634, bathroom, finished basement, attic conversion, and/or the like. In some cases, the tokenization system identifies a change in value from remodeling—renovating kitchens, flooring, bathrooms with higher end finishes, and/or the like. In some cases, the tokenization system identifies a change in value from damage—from natural disasters, accidents, poor maintenance etc. reducing livable space

In some cases, the tokenization system identifies a change in value based on land changes. For example, such changes result from landscaping—upgraded landscaping and hardscaping like a detached patios 602, gazebos, lot changes—subdividing into smaller lots or combining multiple lots into one, soil erosion, flooding 612, landslides and/or the like which can negatively impacting stability, and/or the like.

In some cases, the tokenization system identifies a change in value based on external changes. The tokenization system identifies neighborhood improvements—new parks (such as park 604), schools, developments, roads 614, public transport 610, schools 606 a new mall 608, and/or the like, neighborhood deterioration—increased crime, noise, congestion due to external factors, and/or the like, zoning changes 618—rezoning from residential to commercial or vice versa, and/or the like, or changes to local amenities—addition or removal of malls, offices, hospitals, and/or the like.

In some cases, the tokenization system identifies a change in value based on market conditions. The tokenization system identifies real estate trends—pricing bubbles or bursts for geographic area and property types, interest rate 616 changes—increasing rates reduce affordability and demand, inflation—rising costs increase replacement value, demographic shifts—changing demand for location, property types, features, and/or the like.

In some cases, the tokenization system identifies a change in value based on legal changes, such as tax policy changes—increased or decreased property tax rates, rent control—limiting rent increases reduces income potential, liens—outstanding debts reducing ownership equity, easements—access rights reducing exclusivity, and/or the like.

In some cases, the tokenization system identifies a change in value based on ownership changes, such as death, divorce or debts of owners leading to distressed sales below market value, ownership consolidation through mergers increasing monopoly pricing power.

In some cases, the tokenization system identifies a sale of property 622 sold on an adjacent lot or in the neighborhood. The tokenization system can apply this data to compare the sold price and features of the sold home with the current home to make a better and more current assessment of the property, such as by training the machine learning model on the newly sold home.

### Asset Right of Use and Ownership

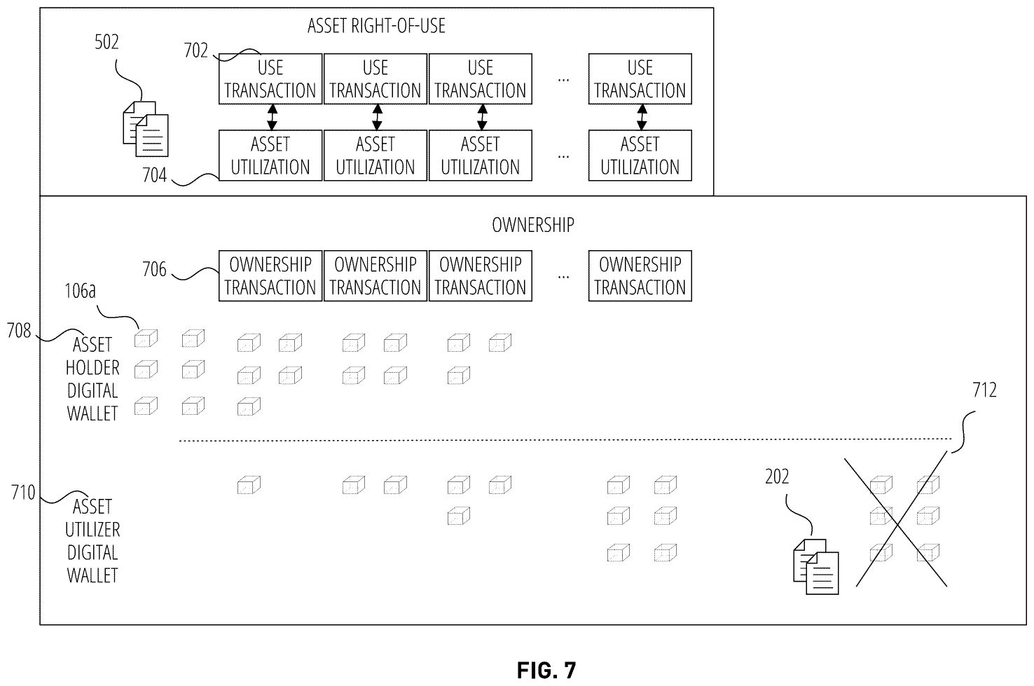

FIG. 7 illustrates an example architecture for the right of use and ownership of an asset, according to some examples. The asset holder provides a digitized asset rights document 502, such as a deed, to the tokenization system.

Subsequently to the tokenization system receiving the digitized asset rights document, the tokenization system identifies a value of the real-world asset. This could involve using data from the asset rights document, such as the purchase price or the assessed value, obtaining an independent appraisal, and/or performing market analysis (e.g., using models such as machine learning models).

The system then generates a plurality of digital tokens, such as token 106a corresponding to the value of the real-world asset. Each token represents a fractional ownership interest in the asset. The number of tokens is determined by dividing the value of the asset by the value of each token. Once the tokens are generated, the tokenization system transmits the tokens to an asset holder's digital wallet 708.

In some cases, the asset utilizer, such as a tenant, submits a use transaction 702 to the system. This transaction enables the tenant's asset utilization 704. The use transaction could include various details, such as the amount of the payment, the period of time for which the payment covers the use of the asset, and the specific portion of the asset that the tenant is paying to use. For example, the tenant could be paying to use the whole house, a specific room, or the asset during a specific period of time.

In some cases, the tokenization system automatically enables access to the asset. For example, the tokenization system automatically configures digital locks or security systems. In some cases, the tokenization system generates a unique access code for the asset utilizer upon receipt of the use transaction. The tokenization system sends the asset utilizer this code, allowing them to access the property.

In some cases, the tokenization system uses smart contracts on the blockchain to automatically grant access rights to the asset utilizer. The smart contract is programmed to change the status of the asset to ‘in use’ by the asset utilizer upon receipt of the use transaction. Such a status initiates (and/or the smart contract initiates configuration of) proper technology, as described herein, to enable access to the property.

In some cases, the tokenization system configures Internet of Things (IoT) devices that are connected to the asset. The tokenization system sends commands to these devices to grant access to the asset utilizer. For example, the tokenization system sends a command to unlock the doors of a rental property or to activate utilities of a car.

For assets such as rental properties or shared spaces, the tokenization system integrates with existing reservation platforms. Upon receipt of the use transaction, the tokenization system automatically books the property for the asset utilizer for the agreed-upon period.

In some cases, the tokenization system generates legal documents, such as lease agreements, that grant the asset utilizer the right to use the property. In some cases, the tokenization system generates such documents by identifying relevant data fields and populating the fields with information retrieved. The tokenization system applies the standardized data (as described further herein) to the forms to generate legal documents for the parties to sign.

In some cases, the tokenization system applies a machine learning model to generate such legal documents. The machine learning model is trained to receive information related to the asset, the asset holder, and/or the asset utilizer, and generate legal documents, based on training on historical asset, asset holder, and asset utilizer data.

In addition to the use transaction, the asset utilizer can also choose to purchase tokens that represent equity in the asset in an ownership transaction 706. This could be done at the same time as the use transaction, or it could be done separately. Such ownership transaction 706 can occur as a separate transaction or in the same transaction as the use transaction 702. The number of tokens that the tenant purchases is determined by the amount of monetary value the tenant applies divided by the token value. For example, if each token is worth $100 and the tenant chooses to put $100 towards equity, then as shown in FIG. 7, one token is transferred from the asset holder digital wallet 708 to the asset utilizer digital wallet 710.

The system processes the use transaction and the token purchase by updating the blockchain or the database to reflect the new token ownership. This could involve the blockchain debiting the tenant's account for the amount of the use transaction and the token purchase, crediting the asset holder's account for the asset utilization, debiting the asset holder's digital wallet of one token, and crediting the asset utilizer's digital wallet of the one token.

In some cases, the asset utilizer does not have the ability to sell tokens purchased through the ownership transactions during pendency of use. In other cases, the asset utilizer has the ability to exchange the tokens for other things of monetary value, such as money. The asset utilizer can sell the tokens back to the asset holder and/or on the open market. Upon sale of the tokens, other third parties can own the tokens. In some cases, these third parties now are fractional owners of the real world asset. In other cases, these third parties instead are owners of equity that can be applied to other similar real world assets.

The tokenization system determines that the asset utilizer has sufficient tokens to gain ownership of the home by comparing the quantity of digital tokens within the asset utilizer's digital wallet to the number of digital tokens corresponding to the value of the real-world asset. Upon determining that the asset utilizer has sufficient tokens, the tokenization system initiates the transfer of ownership.

In some cases, the tokenization system updates the digitized asset rights document, such as a deed or title, to reflect the asset utilizer as the new owner. The tokenization system creates a new digitized asset rights document with the asset utilizer's name and invalidating the previous document, or by updating the owner field in the existing document. The updated asset rights document is then recorded on the blockchain or in the database, providing a clear and indisputable record of the asset utilizer's ownership.

In some cases, the tokenization system leaves the tokens in the asset utilizer digital wallet. In other cases, the tokenization system purges 712 the tokens from circulation. If the tokenization system keeps the tokens in the asset utilizer digital wallet, the asset utilizer can use them to rent the asset to another tenant, effectively becoming the new asset holder. If the tokens are purged, the tokenization system removes the tokens from the asset utilizer's digital wallet and update the blockchain or database to reflect the reduced supply of tokens. Advantageously, purging of the coins prevents the asset utilizer from selling the property using the tokens and/or selling the property separately using the asset ownership document.

In some cases, the asset utilizer can determine an amount of tokens remaining until full ownership and make a full transaction to own the required tokens. For example, in the middle of the asset utilization period, the asset utilizer owns 4 tokens but needs 6 more for full ownership. The asset utilizer can initiate a transaction to purchase all 6 tokens. The tokenization system can then initiate completion of asset ownership transfer at that time.

Examples described herein are described according to one real world property. However, it is appreciated that the examples and features can apply to a collection of assets, such as a portfolio of properties owned by a developer or a real estate company. In this case, the “real world asset” referred to herein include multiple individual assets, each of which could be a separate property.

The asset holder provides digitized asset rights documents for each property in the collection. The system identifies the total value of the collection of properties. The system generates digital tokens corresponding to the total value of the collection of assets. Each token represents a fractional ownership interest in the entire collection, not just a single property. Thus, an asset utilizer who purchases tokens is gaining equity in the entire collection of properties, not just one property.

The asset utilizer is able to use one of the real world assets in the collection, such as by renting a property. The system checks whether the quantity of tokens in the asset utilizer's digital wallet equals or exceeds the number of tokens corresponding to the value of the collection of assets. If it does, the tokenization system transfers full ownership to the collection of properties to the asset utilizer. The system transfers the digitized asset rights documents for the entire collection of assets to the asset utilizer.

In some cases, the real world property use can collect rent for usage of the property and distributed among the token holders. For example, a flat rate can distributed to each token holder. In some cases, the distribution is based on a number of tokens or percentage of ownership or usage rights based on the number of tokens. In some cases, the distribution is based on which of the real world properties are used or which usage rights are used. For example, one user may get more or all of the rent distributions for a particular use while another user gets more or all of the rent distributions for another use.

This approach allows a developer or real estate company to tokenize a portfolio of properties and sell fractional ownership interests to multiple asset utilizers. It provides a flexible and efficient way for asset utilizers to gain equity in a collection of properties, and it allows the asset holder to raise capital by selling tokens.

The system ensures proper ownership transfer by maintaining a clear and immutable record of all transactions related to the asset, including the initial tokenization of the asset and all subsequent transfers of tokens. This record serves as a digital chain of title, providing a transparent history of the asset's ownership.

When the asset holder first submits the digitized asset rights document (such as a deed) to the system, the system records this transaction on the blockchain or in a secure database. This initial record includes the asset holder's identity, the value of the asset, and the number of tokens generated.

Each time tokens are transferred from one digital wallet to another, the system records the transaction. This includes transfers from the asset holder to the asset utilizer (such as a tenant), as well as any subsequent transfers between different asset utilizers. Each record includes the identities of the sender and receiver, the number of tokens transferred, and the time of the transfer.

When the quantity of tokens in the asset utilizer's digital wallet equals or exceeds the total number of tokens corresponding to the value of the asset, the system recognizes this as a transfer of ownership. In other cases, the system provides the option of transfer of ownership. The system updates the digitized asset rights document to reflect the asset utilizer as the new owner and records this transaction.

The system maintains a complete record of all these transactions, creating a digital chain of title for the asset. This chain of title provides a clear and indisputable history of the gradual change in asset's ownership as well as the final transfer of full ownership.

By maintaining this digital chain of title, the system ensures that the ownership transfer is transparent, secure, and legally valid. The block chain technology used in this process provides additional security by making the record immutable, meaning it cannot be altered or deleted once it's been recorded. This prevents fraud and disputes over ownership, providing peace of mind for all parties involved.

In some cases, the tokenization system generates legal documents to formalize each transfer of ownership. For example, when the asset utilizer acquires enough tokens to become the owner, the system could generate a new deed or title in the asset utilizer's name for the asset utilizer and the asset holder to sign. This document would be legally binding and could be recorded with the appropriate government agency.

In some cases, the tokenization system applies a machine learning model that is trained to generate required documents for a particular property. For example, the machine learning model generates different documents for an apartment complex, a single family home, a commercial property, or for an automobile. In some cases, the machine learning model generates documents required for different jurisdictions, such as based on state law or documents needed for foreign jurisdictions.

In some cases, upon the asset utilizer acquiring enough tokens, the system uses a third-party escrow system to hold the digitized asset rights document and oversees the transfer of ownership. The escrow system ensures that the asset utilizer has enough tokens before transferring the document to them.

In some cases, the tokenization system uses digital signatures to authenticate each transaction. Both the sender and receiver of tokens signs each transaction (such as with their private keys), providing a secure and verifiable record of the transaction.

In some cases, the system integrates online notary systems to notarize the transfer of ownership. This would provide an additional layer of legal assurance that the transfer is valid.

In some cases, the system automatically records, such as at a government agency database, a change of ownership. For example, the government agency database can hold a chain of title for a real estate property. The tokenization system initiates transmission of a message to the government agency database for the recordation of the new ownership to add to the chain of title.

In some cases, the system creates a new token recordation system that replaces and/or augments a centralized database, such as a government agency database. This can be useful if government agency databases are not complete and/or if no database currently exists.

In some cases, the tokenization system applies a machine learning model to optimize various aspects of the tokenization system. In some cases, the tokenization system applies historical data to the machine learning model, such as historical digital physical property titles, historical contracts between the owner and user of the real world asset, and/or the like and trains the model to generate an optimal asset transaction, such as an amount or value of the asset, and/or usage duration of the asset. The tokenization system uses the amount or value of the asset to verify a transaction as being within an acceptable range of the valuation.

The tokenization system trains a machine learning model using previous real estate contracts associated with different properties. Based on various factors such as property value, location, market conditions, historical trends, and more, the machine learning model is trained to estimate an optimal transaction amount and/or contract duration for a new property that's being tokenized.

For example, if the property is similar to previous assets, the machine learning model is trained from historical data to suggest terms based on an assessment of what happened for the previous assets. The machine learning model is trained to determine how quickly tokens were purchased for past property, any trends in token purchases, and so forth, to suggest a contract duration. Similarly, the machine learning model is trained to look at token prices in relation to the property value to suggest an optimal token price.

In some cases, the machine learning model is trained to perform one or more features of the tokenization system on assets that are non-similar. The machine learning model receives as input various characteristics of multiple properties, generate hidden latent variables across the different properties that factor into valuation, and applies such latent variables to compare properties that are dissimilar.

The tokenization system applies such models for the benefit of various entities. The tokenization system can help the asset holder in determining the parameters for their token offering. The tokenization system can help the tenant in evaluating different tokenization offers and finding the one that matches their financial capacity and goals. The tokenization system also applies such models to smart contracts to verify transaction by ensuring the values are within the range of values that the machine learning model estimates or outputs.

In some cases, the tokenization system trains a machine learning model by applying input lease agreements associated with different assets to determine the forecast expected total cost to a tenant for ownership and provide a comparison for different options.

The tokenization system trains a machine learning model to analyze past contracts and/or current market conditions to forecast a value a tenant could expect to submit over time to gain ownership of a property using the digital tokens. The machine learning model is also trained to compare this total value against other options, such as compared to traditional home buying or other tokenized processes.

The tokenization system trains a machine learning model to use various inputs such as the property's token price, the length of the contract, market trends, and other relevant data. The model can process this information to generate a projection of total value to be submitted and uses this forecast to compare different home ownership options. The tokenization system helps tenants make informed decisions about the most cost-effective way to gain homeownership.

In some cases, the tokenization system trains a machine learning model to review a smart contract and translate the contract into a form aligned with certain tenant specified criteria. Smart contracts include self-executing contracts with the terms of the agreement directly written into code. The smart contracts detail the terms of the tokenization agreement, including token price, number of tokens, contract duration, and/or the like.

The machine learning model receives the smart contract code as input and translate the code into a format that aligns with the tenant's specific criteria or requirements, such as reinterpreting the terms into a more readable format, highlighting key terms and conditions, or mapping terms to specific criteria set by the tenant.

As such, the tokenization system applies such a machine learning model to help tenants to quickly understand the terms of various tokenization contracts, and how they align with their specific needs and goals. It would make the process of comparing and choosing between different tokenization options more accessible and user-friendly.

Although the machine learning model is described to perform certain steps herein, it is appreciated that the machine learning model can facilitate and/or perform one or more features of the tokenization system, such as asset valuation, generation of tokens, transmitting of tokens from one wallet to another, providing usage to an asset user, and/or the like.

### Physical Property Right of Use and Ownership Over Two Properties

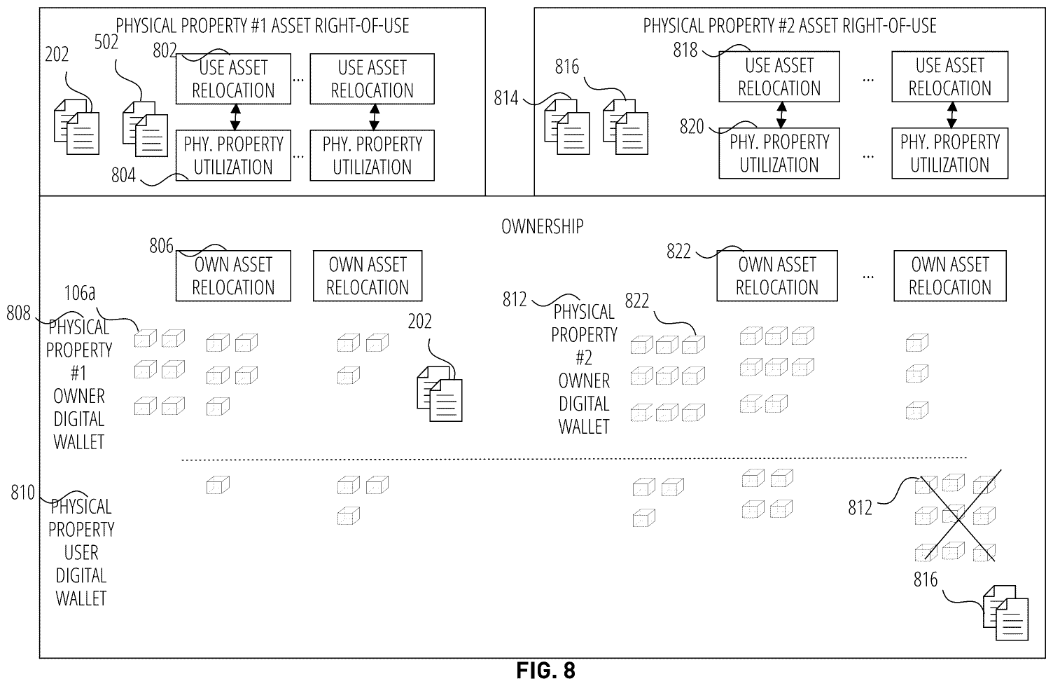

FIG. 8 illustrates an example architecture for the right of use and ownership of two properties, according to some examples. The physical property owner provides a digital physical property title (e.g., deed 202), to the tokenization system.

Subsequently to the tokenization system receiving the digital physical property title (and/or a digitized asset rights document), the tokenization system identifies a value of the physical property (and/or an asset). The system then generates a plurality of virtual asset units (and/or tokens), such as virtual asset unit 106a corresponding to the value of the physical property. Once the virtual asset units are generated, the tokenization system transmits the virtual asset units to a physical property #1 owner virtual asset storage 808.

In some cases, the physical property user, such as a tenant, submits a use virtual asset relocation 802 to the system to gain physical property utilization 804. In addition to the use virtual asset relocation, the physical property user can choose to purchase virtual asset units that represent equity in the physical property in an own virtual asset relocation 806. This could be done at the same time as the use virtual asset relocation, or it could be done separately. Such own virtual asset relocation 806 can occur as a separate transaction or in the same transaction as the use virtual asset relocation 802. The number of virtual asset units that the tenant purchases is determined by the amount of monetary value the tenant applies divided by the virtual asset unit value. For example, if each virtual asset unit is worth $100 and the tenant chooses to put $100 to equity, then as shown in FIG. 8, one virtual asset unit is transferred from the physical property #1 owner virtual asset storage 808 to the physical property user virtual asset storage 810.

After one or more use periods have passed, the physical property user accumulates three virtual asset units, such as virtual asset units 106a, 106b, and 106c, into the physical property user digital wallet. After a physical property use period (such as a lease term), the physical property user (such as a tenant) may opt not to renew the use period. Some tenants may not want full ownership of the property in question or may need to relocate due to unforeseen circumstances such as job transfer, family expansion, or even personal preferences such as a desire for a change in environment.

In such cases, the physical property #1 utilization agreement (e.g., lease agreement 502), upon reaching its expiry, either lapses naturally or is terminated. In the tokenization system, the tenant's decision not to continue leasing the property or pursuing full ownership does not result in a complete loss of their investment, as it would be in a traditional rental scenario. The virtual asset units representing their fractional ownership and fungible equity in the property are retained by the physical property user. In some cases, the virtual asset units are not tied to a property but rather represent a certain amount of value in real estate equity. The physical property user can apply the three tokens in the physical property #1 owner virtual asset storage to another property.

The digital physical property title, representing the legal ownership of the property, is returned to the physical property owner. This transfer of ownership can be done digitally, such as by leveraging blockchain technology to ensure the process is transparent, efficient, and secure. In some cases, the tokenization system releases a lien on the title, as the property owner now reclaims complete ownership of the property. As such, the digital physical property title (e.g., deed 202) is returned to the physical property #1 owner digital asset storage 808. As described herein, the tokens are purged from circulation.

Once the physical property user has acquired a certain number of virtual asset units from the first property and decided to move to another property, these virtual asset units can be applied to ownership of the new property. The tokenization system leverages the fungibility of the virtual asset units, which represent a set value of real estate equity and can be used to any property within the tokenization system.

For example, let's say the value of the first property was represented by 6 virtual asset units, and the physical property user had managed to acquire 3 virtual asset units during the utilization term. If the physical property user decides to move to a second property, these 3 virtual asset units remain with the physical property user and represent a significant amount of equity that can be transferred to the next property.

When the physical property user decides to move to a second property, the tokenization process for the new property can include one or more of the same processes for the first property. For example, the tokenization system begins by receiving the digital property title 816 of the second property from the second physical property owner.

Next, the tokenization system generates a use document 814, such as a lease agreement. This document stipulates the terms and conditions of the property use, including the use term, the required use asset relocations to be submitted, and asset relocations for ownership (own asset relocations) to acquire additional virtual asset units.

The tokenization system can determine that the value of the second property is 9 virtual asset units. Using the established token value, the system determines the total number of tokens that represent the full value of the second property. For example, if the second property is valued at a level that would equate to 9 tokens, this is the total number of tokens that would represent full ownership of this property.

The physical property user initiates use asset relocation 818 for physical property utilization 820 and own asset relocations 822 for acquisition of additional virtual asset units. FIG. 8 illustrates that the physical property user digital asset storage 810 starts with 3 virtual asset units and continues to acquire virtual asset units until the user has 9 virtual asset units.

The tokenization system determines that the physical property user has sufficient virtual asset units to gain ownership of the second physical property by comparing the quantity of digital virtual asset units within the physical property user's virtual asset storage to the number of digital virtual asset units corresponding to the value of the physical property (a total of 9 for the second physical property in FIG. 8). Upon determining that the physical property user has sufficient virtual asset units, the tokenization system initiates the transfer of ownership.

In some cases, the tokenization system updates the digital physical property title 816, such as a deed or title, to reflect the physical property user as the new owner. The tokenization system creates a new digital physical property title with the physical property user's name and invalidating the previous document, or by updating the owner field in the existing document. The updated digital physical property title is then recorded on the blockchain or in the database, providing a clear and indisputable record of the physical property user's ownership. In some cases, the digital physical property title 816 is transferred to the physical property user digital virtual asset storage 810.

In some cases, the tokenization system leaves the virtual asset units in the physical property user virtual asset storage. In other cases, the tokenization system purges 812 the virtual asset units from circulation.

In some cases, the physical property user can determine an amount of virtual asset units remaining until full ownership and make a full transaction to own the required virtual asset units. For example, in the middle of the physical property use period, the physical property user owns 4 virtual asset units but needs 6 more for full ownership. The physical property user can initiate a transaction to purchase all 6 virtual asset units. The tokenization system can then initiate completion of physical property ownership transfer at that time.

### Collection of Physical Commodities

Some examples described herein are described according to one real world property. However, it is appreciated that the examples and features can apply to a collection of assets, such as a portfolio of properties owned by a developer or a real estate company. In this case, the “physical commodity” referred to herein include multiple individual assets, each of which could be a separate property.

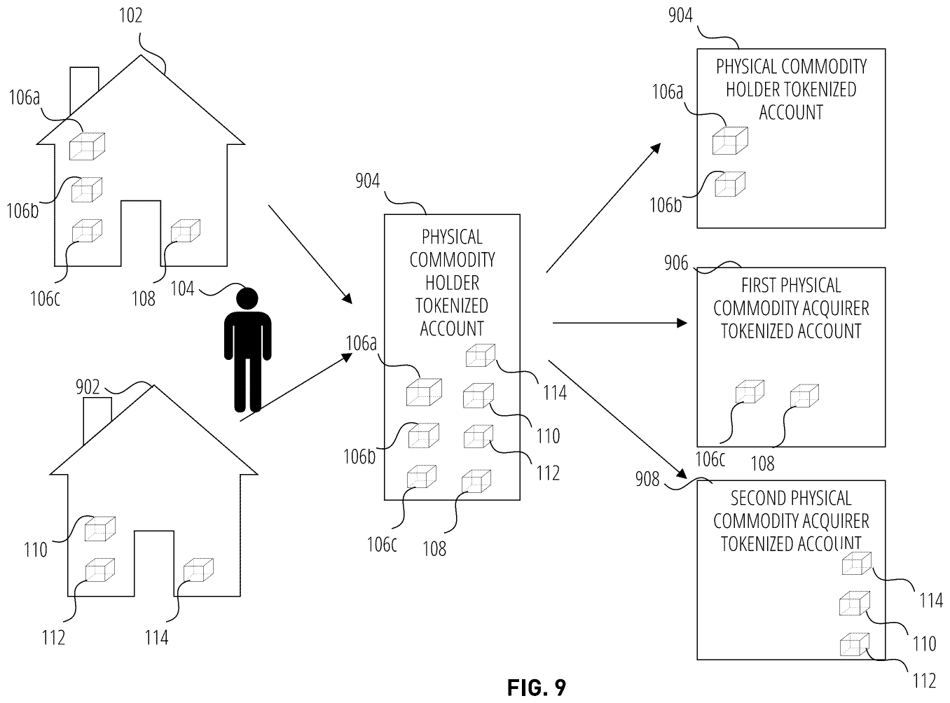

FIG. 9 illustrates ownership transfer for a collection of physical commodities, according to some examples. For example, the assets can be equivalent to a certain set amount of tokens. In other examples, the assets acquire tokens based on the value of the individual asset (e.g., the tokens are set to a particular price, and the tokens given to an individual asset are based on the number of tokens equivalent to the asset value).

The physical commodity holder provides digitized asset rights documents for each property in the collection. The system identifies the total value of the collection of properties, such as for home 102 and home 902. The system generates fractionalized property tokens corresponding to the total value of the collection of assets, such as tokens 106a, 106b, 106c, 108, 110, 112, and 114. Each token represents a fractional ownership interest in the entire collection, not just a single property. Thus, a physical commodity acquirer who purchases tokens is gaining equity in the entire collection of properties, not just one property.

The tokens can be transferred to a physical commodity holder tokenized account 904. In some cases, the tokens are transferred to two separate accounts, such as a first physical commodity holder tokenized account for the first home 102, and a second physical commodity holder tokenized account for the second home 902.

A first physical commodity acquirer purchases tokens 106c and 108, and the second physical commodity acquirer purchases tokens 114, 110, and 112. The tokenization system transfers tokens 106c and 108 to the first physical commodity acquirer's tokenized account 906 and tokens 114, 110, and 112 to the second physical commodity acquirer's tokenized account 908. The physical commodity holder maintains partial ownership by holding tokens 106a and 106b in the tokenized account 904.

This approach allows a developer or real estate company to tokenize a portfolio of properties and sell fractional ownership interests to multiple physical commodity acquirers. It provides a flexible and efficient way for physical commodity acquirers to gain equity in a collection of properties, and it allows the physical commodity holder to raise capital by selling tokens.

Applying Machine Learning Models to Features of the Tokenization System

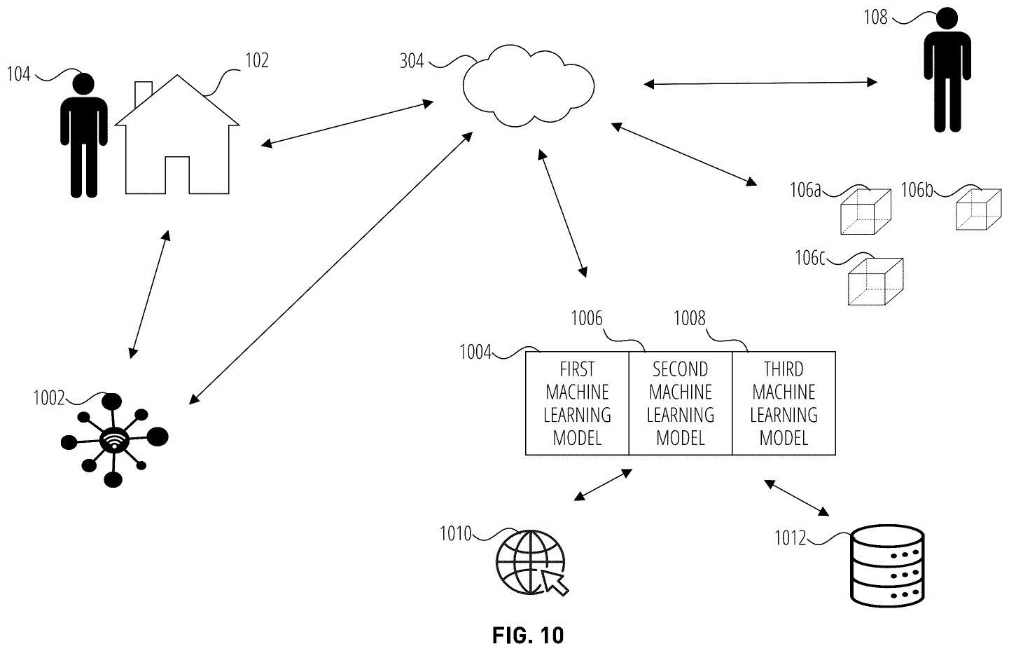

FIG. 10 illustrates the application of machine learning models to features of the tokenization system, according to some examples. The asset owner 104 starts by creating an account on the tokenization platform and providing identity verification. The asset owner can submit documents to the tokenization system, such as a driver's license or passport, proof of address, etc.

Next, the asset owner registers the real world property that they want to tokenize. The asset owner provides details and documentation related to the property to the tokenization system such as: type of property (home, apartment, commercial building, farm land, etc.), address and identifying details, documentation proving ownership such as property deed, title, etc., any existing liens, loans, or encumbrances on the property, current assessed value of the property, recent appraisal or valuation of the property if available, and/or the like.

In some examples, the asset owner registers an airline seat providing a specific flight number and date, departure and arrival airports, seat number, seat class (first, business, economy), associated amenities (priority boarding, lounge access, etc.), duration of access being tokenized (one-way, roundtrip), and/or the like.

In some examples, the asset owner registers land, such as farm land, and provides total acreage, location/address, type of crops grown, water rights, existing liens or encumbrances, leases or tenant agreements, farm equipment or infrastructure details, mineral rights, grazing rights, and/or the like.

In some examples, the asset owner registers an automobile providing VIN number, make, model, year, current mileage, service and maintenance history, existing liens or loans, usage details (daily, weekly, mileage-based), insurance coverage, pickup/dropoff locations, and/or the like.

In some cases, the asset owner provides information such as any permits, licenses, or legal designations, usage capacity or size constraints, existing reservations or schedule of usage, relevant maintenance schedules or costs, required training or certifications for usage, environmental/weather constraints on usage, and/or the like.

The asset owner also provides information on the types of usage rights or fractional ownership shares they want to create. For example, they may want to sell weekly timeshares, divide ownership into 10% shares, or create tokens for one-time access.

Once submitted, the tokenization platform verifies the documentation, ownership, and details related to the property. This may involve checking public records, validating documents, and confirming the property exists and matches the details provided. In some cases, a first machine learning model 1004 is applied to perform verification of documentation, ownership, and/or details related to the property. The first machine learning model accesses websites 1010 or third party databases 1012 to verify such information, such as the DMV's website or property title databases.

After the property is registered, the tokenization system determines the total value of the property and/or the value of the usage rights or ownership shares. The system can analyze the documents and details provided by the owner, including any recent appraisals. The system retrieves current property records and valuations from public sources. In some cases, the system uses machine learning models, such as the second machine learning model 1006, trained on historical property transactions, prices, and attributes to estimate the current fair market value of the property. This property valuation model considers factors such as property type, size, location, assessed value, recent sales prices of comparable properties, property condition, renovations, improvements, current real estate market conditions, and/or the like.

Once the total property value is estimated, the system determines the value of the specific usage rights or ownership shares specified by the owner. The shares are priced based on factors like time duration, frequency, amenities or features that can be accessed.

With the total value and share values determined, the system mints tokens on the blockchain representing the total value and the individual usage/ownership shares. The tokens are programmatically assigned to the asset owner's account on the platform.

The asset owner can then make the various token shares, such as tokens 106a, 106b, 106c, available for purchase by other users of the platform, such as tenant 108. The system tracks ownership and transfers of the tokens on the blockchain. The tokenized shares can also be traded on secondary markets and exchanges, while the tokenization platform continues tracking ownership.

In some cases, the tokenization platform has an API (Application Programming Interface) that connects to IoT (Internet of Things) devices installed on the physical property. When a user purchases tokens, the system sends a signal (such as via API) to IoT devices 1002 on the property (such as home 102) enabling access by the tenant 108. The system verifies token ownership prior to granting access.

These IoT devices could include smart locks on doors, gates, or entryways, garage door openers with internet connectivity, smart thermostats to control heating/cooling, smart lighting systems, security cameras and alarm systems, any other sensors, controls, or automation devices, and/or the like.

When a user purchases usage or ownership tokens for a property, this transaction is recorded on the blockchain ledger. The tokenization platform continually monitors the blockchain to check for any token purchases or transfers related to registered properties.

When a relevant token transaction is detected, the platform looks up the API credentials for the IoT devices on that property. These credentials are stored securely on the platform. The platform then prepares an API call including the wallet address of the user who purchased the tokens, the specific tokens purchased (for example, a 7-day timeshare), the dates, times, locations, or other details related to the token access rights, a cryptographic signature to verify the authenticity of the request, and/or the like.

This API call is sent to the IoT devices on the property to notify them of the newly authorized user. The IoT devices check the blockchain to independently verify that the user's wallet address indeed holds the relevant usage tokens.

After validating the token purchase, the IoT devices activate features to grant access to the user. For example, the IoT device enables unlocking doors or gates, disabling alarms, turning on lighting and HVAC, adding the user's device to the WiFi network, and/or the like.

When the usage period expires, the platform sends another API call revoking the user's access rights. The IoT devices confirm the expired tokens and disable access. The IoT devices maintain the autonomy to independently verify tokens and only grant access according to on-chain ownership records.

In some cases, the IoT devices provide usage rights to land, such as farm land via smart gates—gates with connected locks allow remote access control to fields or barns, autonomous tractors—tractors with sensors and GPS can be programmed to automatically till, seed, or harvest fields based on usage rights, environmental sensors—sensors for soil moisture, crop growth, and livestock feeding patterns allow remote monitoring of farm assets, and/or the like.

In some cases, the IoT devices provide usage rights to automobiles via digital keys—bluetooth enabled keys that can lock/unlock doors and start cars remotely based on token permissions, telematics devices—plugged into car ports, these devices can track vehicle location, usage, and disable ignition remotely if needed, and/or the like.

In some cases, the IoT devices provide usage rights to airline tickets via airline booking using interactive kiosks—self-service kiosks can allow fliers to check-in and print boarding passes by scanning digital tokens, e-tickets—tokens representing booking rights can be scanned from mobile devices to grant airport/lounge access and board flights, biometric scanners—face/fingerprint readers at gates that validate identity along with token ownership for touchless boarding, and/or the like.

In some cases, the IoT devices provide usage rights using smart locks-tokenized access rights for buildings, hotel rooms, storage units secured via connected, digital locks, usage meters—smart meters on machinery/equipment track usage data and regulate access based on token allowances, digital ticket stubs—concert/event venues can scan tokenized ticket ownership on mobile devices to grant entry, and/or the like.

In some cases, a third machine learning model 1008 is applied to process ownership documents like deeds, extracting key fields through OCR and structuring data. This automates document ingestion. The tokenization system can apply a machine learning model trained to ingest legal ownership documents like property deeds in order to verify asset ownership before minting tokens.

These documents contain unstructured data like text, tables, signatures, diagrams etc. Making sense of this data requires specialized document processing capabilities. The machine learning model applies optical character recognition (OCR) to scan image-based documents and identify textual elements. However, raw OCR output is unstructured and still difficult to interpret. A machine learning model is to better structure the data and extract key fields. The model can detect sections of the document using visual cues like headings, spacing, borders etc. This breaks the text into logical chunks.

Within each section, the model can identify key fields like property address, owner name, legal description etc. using natural language processing techniques like named entity recognition. The model can extract values associated with each identified field. It can also cross-validate values across sections to improve accuracy. The model can classify other document elements like tables, diagrams, signatures etc. and structure them appropriately.

Documents often have different formats across counties/states. The model can learn these nuances from training data and adapt accordingly. The structured output is then saved in a standardized JSON format with clear labels, making it easy to query and validate against other data sources.

Given a property value and token parameters, the tokenization system applies a machine learning mode model trained to determine the optimal number of tokens to mint and token value based on analyzing similar prior tokenizations. A machine learning model can analyze training data and the model can learn relationships between the inputs and optimal tokenization parameters.

The machine learning model can be trained to determine an optimal number of tokens to create based on property value, optimal face value per token based on affordability, accessibility and liquidity goals, expected rate of token purchases based on historical demand, projected appreciation in property and token values based on location, trends, etc, and/or the like. The model output provides data-driven, customized recommendations for structuring the tokenization for a particular property. This maximizes benefits for the asset owner as well as prospective token buyers.

In some cases, the tokenization system applies a machine learning model trained to evaluate token transactions, like purchases/sales, to detect fraud by analyzing each user's profile, transaction history, and other context, bolstering security. When tokens are bought, sold or transferred between parties, the transactions need to be validated to prevent fraudulent activities.

A machine learning model can analyze each transaction in real-time to identify potential risks or suspicious patterns. The model can take into account multiple factors, such as user profile data like identity, location, occupation, income level, etc, user transaction history—frequency, amounts, sources/destinations of past transfers, transaction details—amount, source account, destination, time, currency, etc, token history—previous owners, length of ownership, transactions over time, external context—-real-world events, market conditions, regulatory changes, etc., and/or the like.

The model ca be trained on historical transaction data labeled as legitimate or fraudulent and can learn to perform certain checks, such as profile consistency checks—detect mismatches in user profile vs transaction details, behavioral analysis—identify sudden deviations from normal behavior patterns, relational learning—spot connections between users/accounts involved, rules-based analysis—apply regulatory rules to detect reporting breaches, anomaly detection—discover outliers deviating from expected patterns, and/or the like.

Based on this multifactor analysis, the model can generate a risk score for each transaction. High-risk transactions can be flagged for further manual review or blocked outright. The tokenization system continuously trains model as new transaction data comes in, enhancing its detection accuracy over time.

In some cases, the tokenization system applies a machine learning model that generates and/or facilitates execution of smart contracts that generate encoding rental agreements and ownership transfers. The models can analyze templates, property details, and user information to generate such contracts.

Smart contracts include self-executing scripts that encode the legal and business logic governing transactions on a blockchain network. In a property tokenization system, smart contracts can encode rental agreements, token transfers, and ownership transfers.

The models can analyze different information sources to assemble customized contracts, such as contract templates—base templates encode standard clauses, placeholders, and structure, property details—address, value, ownership terms, amenities, restrictions, etc., tenant information—identity, background checks, employment status, references, etc., user preferences—custom terms requested by property owner or tenant, and/or the like.

In some cases, the machine learning model applies natural language processing that can parse templates to understand semantics-identify standard vs customizable clauses, extract relevant details from property/tenant data, translate user preferences into suitable contract language, assemble customized contracts by populating the templates using the extracted details and preferences, and/or the like.

In some cases, the models are trained to learn relationships between property details and contract terms based on historical data, recommend additional customized clauses based on analysis of past contracts, optimize contract structure and language using techniques like readability scoring, and/or the like.

In some cases, the tokenization system applies a machine learning model trained to categorize incoming payments based on source, amount, context and automatically allocate them to appropriate accounts according to predefined logic. In a tokenized system, various payments need to be processed on a recurring basis, such as rental payments from tenants, token purchase payments, proceeds from property usage or services, disbursements to property owners, transfer fees, taxes and other deductions, and/or the like.

The models analyzes key attributes of each payment, such as the source—bank account, wallet, payment processor etc., amount, contextual metadata like tenancy ID, property ID, payment reference IDs, timing—Due date, time received, and/or the like.

The models is trained on labeled historical payments to recognize patterns and categorize new payments, such as classification models to categorize payment type, source, purpose etc., named entity recognition to extract identifiers, names, dates etc., anomaly detection to flag unusual payments for review, and/or the like.

Once categorized, the machine learning model initiates smart contracts with predefined logic that can automatically post the payments to appropriate accounts, such as rental payments credited to property owner's account, token purchases credited to seller's account, taxes deducted and transferred to tax authority accounts, service fees credited to platform account, and/or the like. The smart contracts can also be programmed to cause recurrent payments, installments, refunds etc.

In some cases, the machine learning model is trained to analyze IoT sensor data to detect emerging maintenance issues and schedule proactive repairs for properties. Many real estate assets now have Internet of Things (IoT) sensors installed—like temperature, humidity, motion sensors etc. The sensor data can be analyzed using deep learning models to identify patterns indicative of emerging maintenance issues before they become serious or result in system failure.

In some cases, the machine learning models can analyze temperature, humidity, airflow sensors to detect deviations from normal operating thresholds. This can indicate issues like refrigerant leaks, clogged air filters etc. early. In some cases, the machine learning models can analyze spikes and anomalies in water usage flow rate sensors. This can reveal leaks and pipe blockages. In some cases, the machine learning models can analyze current fluctuation patterns in smart meter data can indicate emerging faults in circuits and wiring.

In some cases, the machine learning models can analyze motion sensors can detect door/window openings at unusual times, captured images can be analyzed for threats. In some cases, the machine learning models can analyze vibration, noise and thermal patterns from machinery like elevators and escalators can indicate wear and tear.

The deep learning models are trained on labeled historical sensor data to detect anomalies and correlate them with actual maintenance issues. Once a pattern is identified, the models can automatically schedule preventative maintenance. For example, the machine learning model is configured to send maintenance requests and details to property managers, coordinating visits with tenants, place orders for necessary contractor services or parts, and/or the like. In some cases, the machine learning models facilitate such processes using smart contracts.

### Fungible Usage Rights

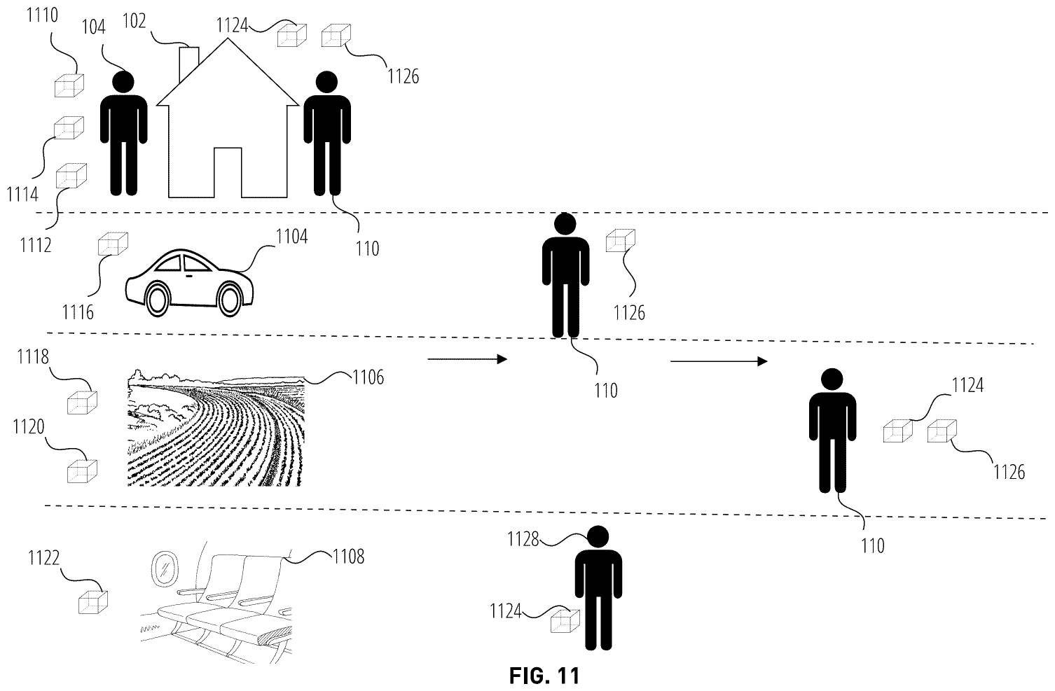

FIG. 11 illustrates fungible usage rights, according to some examples. The user 110 obtains two tokens 1124 and 1126. The user 110 at a first time step desires to use the home 102. The value for the usage of the home 102 is 3 tokens 1110, 1112, and 1114. In some cases, the value of the home itself is worth 3 tokens. The user does not have enough tokens to own the home 102. However, the user can apply 2 tokens so that the user can use part of the home, the home for a particular period of time, the home for a particular purpose, and/or the like.

The user applies the 2 tokens to the home temporarily such that the user becomes partial owner of the home. The fractional ownership is recorded on the real world property ownership certificate indicating that the owner 104 is now a ⅓ owner of the home and the user 110 is a ⅔ owner of the home. In some cases, the tokens enable fractional usage rights. When the user applies 2 tokens to an asset, the user can gain access to ⅔s of the usage rights (as further described herein), such as enabling the user to provide access rights to other third parties.

The real world property ownership certificate includes a digital version of a deed, title, or other legal document that establishes ownership of the real world property. This document is stored in a secure, tamper-proof format of the tokenization system, such as a blockchain or a secure database.

At a next time step, the user 110 decides to end the use of the home 102 and desires to use the car 1104 and an airplane seat 1108. The user retrieves the tokens 1124 and 1126 back from the tokenization system and/or the owner 104 and the tokenization system updates the property ownership certificate for the home. The user applies token 1126 to use the car 1104 where the value for usage is one token 1116.

In some cases, the user can rent or sell his token 1124 to another user 1128 for the other user 1128 to use for the airplane seat 1108 to travel to another country where the value for usage is also one token 1122. In such cases, the property ownership certificate for the car and the airplane seat are updated temporarily to enable users to use or temporary ownership of the car and the airplane seat.

At a next time step, the user decides to use the farm land 1106 where the value for usage of the farm land is 2 tokens 1118 and 1120. The user 110 has his own 2 tokens 1124 and 1126 and applies the two tokens to be able to use the farm land. In some cases, the user has usage rights to be able to loan the asset to another (such as the farm land to a farmer) to collect proceeds from the use of the asset. For example, the user can lease the land to a farmer and collect proceeds from the farmer (such as a rent amount and/or proceeds from the harvest). The tokenization system distributes the proceeds from the third party to the user and/or to the original owner of the asset, such as the original owner of the farm land. Likewise to the home, the tokenization system can record and release liens on these various assets and/or generate or modify property ownership certificates for such assets.

In some cases, the home owner 104 who has home 102 can tokenize the home to collect tokens 1110, 1112, and 1114. the home owner 104 can then apply these tokens to lease the car 1104, farm land 1106, and/or the like.

### Multi-User Multi-Asset-Slot Scenario

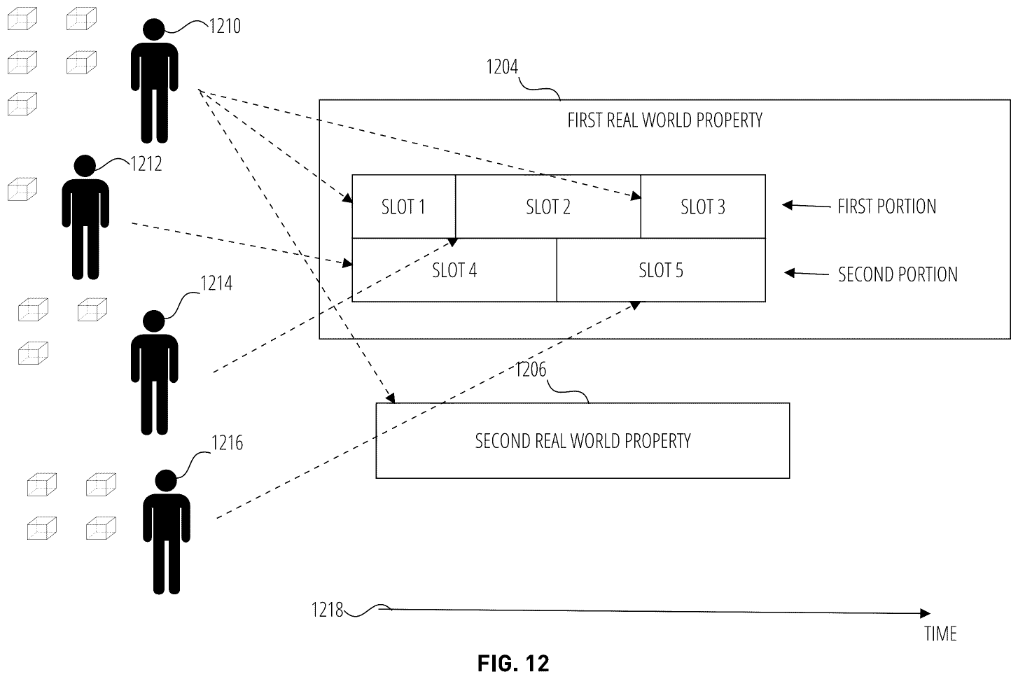

FIG. 12 illustrates an example of a multi-user multi-asset-slot scenario with tokenized real world assets, according to some examples. There are multiple users, such as a first user 1210 with 5 tokens, a second user 1212 with I token, a third user 1214 with 3 tokens, and a fourth user 1216 with 4 tokens.

There are two real world properties, a first real world property 1204 and a second real world property 1206. The first real world property can be two different trucks in a fleet of trucks, represented by a first and second portion. The second real world property can be a transporter.

In some cases, the first user 1210, who has the most amount of tokens, can get first pick from the fleet. In some cases, the selection between users of real world properties occur as an auction, where the user with the highest bid gets access to usage rights of a certain property and/or a time period. In some cases, the tokenization system assigns users based on other characteristics, such as a first come first serve (first user to make a request), need based (e.g., affordable housing and/or factors considered for affordable housing), expected return from usage (e.g., sales from kiosks in tourist district), and/or the like.

In some cases, the first user 1210 gains access to the second real world property 1206 for the entire time period 1218. The first user 1210 also gains access to the first truck in the first and third time slots. The second user 1212 gains access to the second truck at the fourth time slot, the third user 1214 gains access to the first truck at the second time slot, and the fourth user gains access to the second truck at the fifth time slot.

In some cases, the real world property usage rights are single time, single use (such such as perishables), single time, multi use (such as identical rooms in a hotel), multi time, single use (such as a shared cooperative plane used for aerial seeding), multi time, multi use (such as seats on a scheduled train route), and/or the like.

In some cases, the tokenization system determines allocation of usage slots based on need. For example, certain individuals may qualify for affordable housing or may have a more urgent need for a truck in January. The tokenization system accesses various databases to identify user's needs or characteristics that can be assessed to identify user needs (e.g., low income or trucks in repair).

In some cases, the tokenization system applies a machine learning model to determine an optimal allocation of usage slots. The machine learning model can be trained to make such determinations based on one or more factors, such as the needs of the users, improving overall returns for token holders, meeting the needs and timing for the third parties requesting usage, and/or the like. The machine learning model can be trained on historic usage data of users using certain usage slots across time periods (e.g., summer may be more expensive than the winter).

In some cases, the tokenization system applies a machine learning model to determine a risk of a user requesting usage token purchase and/or third parties applying for usage slot. The tokenization system can accept or reject token ownership and/or usage based on a risk for the user and/or third party. The tokenization system implements smart contracts to apply such machine learning models and automatically accept or reject token ownership or usage.

### Virtual Reality Changes Enable Usage Rights to Real World Assets

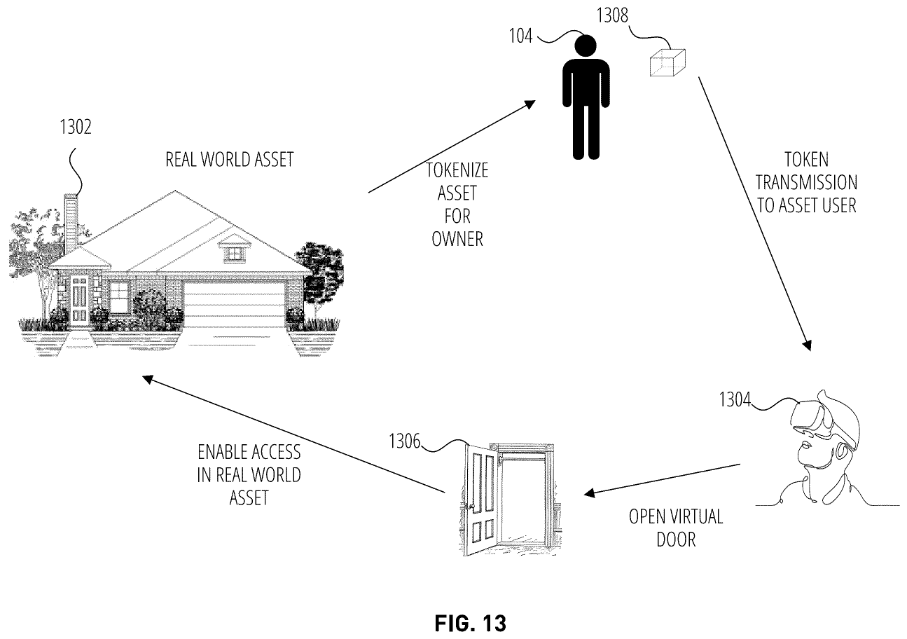

FIG. 13 illustrates virtual reality changes enabling usage rights to real world assets, according to some examples. In some cases, a real world asset 1302 is tokenized in the form of a digital token 1308 for an asset possessor 104.

A user 1304 desires usage rights, and the tokenization system enables the digital token 1308 to be transmitted to the user. The user can then, in virtual reality, augmented reality, or other form of mixed reality, open a virtual door 1306. The tokenization system then transmits a signal, such as via a smart contract, to an IoT device on the real world asset 1302 that unlocks the front door to the home enabling the user to access the home.

For example, the user can be in a completely virtual space unlocking the virtual door and/or the user can be standing in front of the real world asset and select a virtual option in augmented reality to unlock the door. The tokenization system can then send a signal to the IoT device to unlock the door.

IoT devices are deployed on the real world asset. These devices can include sensors, GPS trackers, cameras, or any other relevant technology that can provide real-time data about the asset's condition, location, and usage.

IoT devices continuously collect and transmit data related to the asset. For instance, in a vehicle, data might include information about the vehicle's location, mileage, engine status, fuel levels, and maintenance history.

The data collected by IoT devices is transmitted wirelessly to a centralized data platform. This tokenization platform processes and stores the incoming data for analysis.

Relevant features are extracted from the incoming data. These features could include factors such as distance traveled, engine health, usage patterns, and location history.

Historical data from IoT devices is used to create a labeled dataset. This dataset is divided into training and validation sets for training and evaluating the model. The machine learning model is trained using the labeled dataset. The model learns to identify patterns and relationships between the IoT data and the asset's condition.

The trained model and/or other process of the tokenization system can predict the future condition of the asset based on incoming IoT data. For example, it can predict when maintenance is required for a vehicle or when an asset's value might be compromised.

Machine learning models can identify anomalies in the IoT data, flagging instances where the asset's condition deviates significantly from the expected norm. This helps users or possessors take prompt action in case of potential asset deterioration. If the model detects potential issues with the asset's condition, it can trigger alerts or notifications to both the user and the possessor, ensuring timely action.

Real-time data from IoT devices enables possessors and/or users to assess the risk associated with the asset more accurately. It allows them to make informed decisions based on the asset's actual condition rather than relying solely on assumptions. Asset tracking via IoT devices enhances transparency between user and possessor, as both parties can access real-time information about the asset's condition.

In addition to smart contracts verifying validity of a transaction (such as a payment, token transfer, deed recordation or modification, contract creation, and/or the like) using the blockchain network of nodes, the tokenization system can determine a reasonability metric of a transaction. The reasonability determination can include an objective and/or subjective factor.

The tokenization system applies an objective reasonability transaction factor by causing the nodes of the blockchain to analyze transactional data and/or other data sources. For example, the nodes can analyze the data through a statistical non-deterministic estimation model (such as Monte-Carlo simulation) to determine the expected transaction value. The tokenization system can enable a voting mechanism that can gather the expected results from the different nodes and determine the final value range upon which the transaction can be validated.

For example, a potential tenant is deciding whether to purchase a token based on its expected value in five years. The network of nodes can simulate token behavior based on relevant parameters to arrive at a set of expected values at the end of five years. The voting mechanism can create a distribution of values upon which the potential tenant or intermediary application can use this estimate to help make their decision on particular transactions.

In the case of a subjective reasonability transaction factor, each node evaluates data to arrive at a factor upon which each node casts its vote (such as a valid or invalid response). These votes are gathered and a final decision is made, such as a total percentage of votes meeting a certain threshold. Determining accuracy of such subjective decisions can be done by classifying nodes based on their past performance against actual and training decisions and thus weighing each node's decision to arrive at a final aggregate decision.

For example, the asset owner upgraded their asset and would like to issue new tokens based on the upgrade. The network of nodes evaluates the evidence or data (e.g. permits, photos, descriptions of the updates) and arrive at individual conclusions based on computational or comparison verification or any combination thereof to arrive at a local decision upon which a voting mechanism would determine the final overall decision.

The tokenization system enables the decision making process to be performed within the blockchain network. In some cases, the tokenization system enables the ability to further appeal decisions in multiple stages within the blockchain, such as by enabling users to provide more evidence or data.

In addition, the nodes responsible for making the decisions can be isolated to the nodes owning tokens that were created by the same asset owner, nodes that own any tokens belonging to our system, any nodes on the block chain network, and/or the like.

In some cases, a machine learning model can examine previous transactions stored on blockchain by the asset owner to determine their credit worthiness. In some cases, the machine learning model uses this to generate transaction information (such as contract terms).

A machine learning model can perform creditworthiness checking by analyzing various data points related to an individual's financial history, behavior, and other relevant information to determine the likelihood of them repaying a loan or credit.

Relevant data is collected from various sources, including credit bureaus, financial institutions, and other data providers. This data includes information such as credit scores, credit reports, income, employment history, payment history, outstanding debts, and more.

The collected data is analyzed to identify relevant features or variables that can help assess an individual's creditworthiness. These features could include credit utilization ratio, number of open credit accounts, length of credit history, and recent credit inquiries.

Historical data on credit applicants, including how they've used assets in the past, token and payment history, and/or the like, is used to create a labeled dataset. This dataset is divided into a training set and a validation set for training and evaluating the model. The machine learning model is trained on the labeled dataset to learn patterns and relationships between the input features and the qualifications for usage rights. The model's internal parameters are adjusted during training to minimize prediction errors.

Relevant data about the borrower is collected, including personal information, credit history, income, employment status, loan amount, and purpose. This data forms the basis for assessing the borrower's creditworthiness. Machine learning models require relevant features or variables to make predictions. These features are extracted from the collected data, and they can include credit score, debt-to-income ratio, employment history, loan term, and more.

Implementing blockchain technology to create self-executing smart contracts can revolutionize the way usage rights of real world assets are handled. The tokenization system applies a machine learning model to determine contractual terms, and these terms are translated into code and stored on the blockchain as a smart contract. The contract includes details such as different types of usage rights, enabling and disabling usage rights, time periods of allowed and disallowed usage, and/or the like.

The smart contract can be programmed to automatically execute based on predefined conditions. Once the borrower meets the specified criteria (e.g., creditworthiness assessment), the usage rights can be approved without the need for manual intervention.

All transactions and changes to the smart contract are recorded on the blockchain, providing an immutable and transparent record of the contractual agreement's execution. The smart contract enforces the terms of the contract automatically, ensuring that both parties adhere to the agreed-upon conditions.

Smart contracts eliminate the need for intermediaries (e.g., lawyers, banks) and reduce administrative overhead, leading to faster and more cost-effective usage right processes. Moreover, smart contracts are tamper-proof and secure. This reduces the risk of fraud and disputes, as all parties have access to the same, unchangeable record.

### Value Extractions for Property Occupants

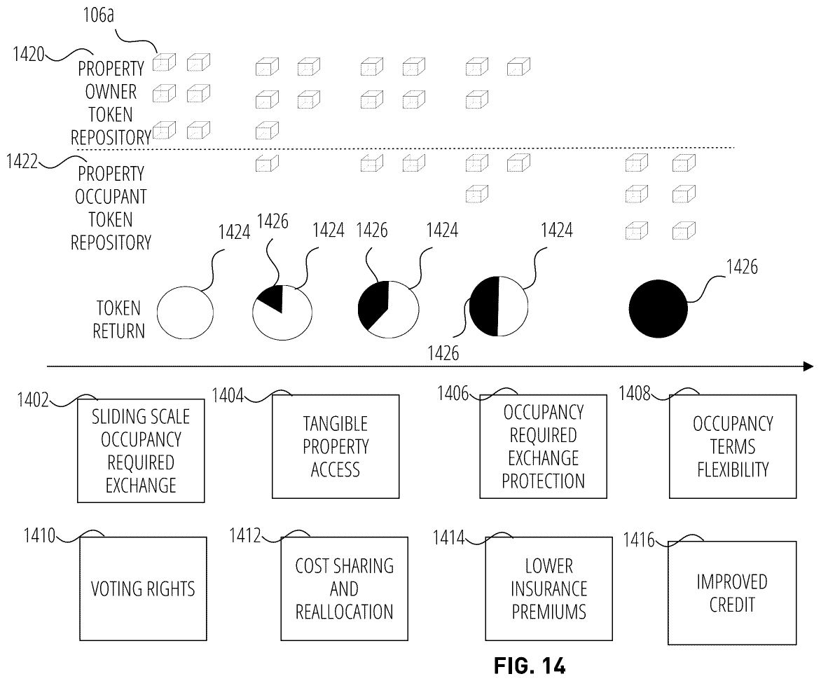

FIG. 14 illustrates examples of value extractions for a property occupant with progressive ownership, according to some examples. Progressive ownership is acquired by the property occupant over time. The property occupant acquires tokens, such as token 106a, from the property owner, resulting in tokens transferred from the property owner token repository 1420 to the tangible property occupant token repository 1422.

With progressive ownership of the tangible property by the property occupant, the portion of benefits progressively also changes to apply more to the property occupant. For example, the portion 1424 of the property owner progressively lessens and the portion 1426 of the property occupant progressively increases with each token acquisition by the property occupant, such that a larger distribution of the token exchange (such as rent payment) is sent to the property occupant over time.

FIG. 14 illustrates a sliding scale occupancy required exchange 1402. As the property occupant accumulate more tokens (which represents their fractional ownership of the property), their monthly rental payments are decreased proportionally. The tokenization system recognizes that as a property occupant gains more ownership of the property through token accumulation, the property occupant should be responsible for a smaller portion of the rental cost. This incentivizes tenants to invest in property tokens, as it directly leads to reduced rental expenses.

As tenants accrue more tokens, the percentage of the rent they receive back as dividends could increase. This scale could be linear, where each percentage increase in ownership corresponds to an equivalent percentage increase in dividends, such as a ratio of tokens owned by the property owner and the occupant. Alternatively, the scale could be designed to provide larger dividends for property occupants who have reached certain thresholds of ownership, further incentivizing long-term investment in property tokens.

In some cases, the tokenization system enables the property occupant to pay a portion of their rent with the tokens they've accrued. The tokenization system enables the property occupant to pay their rent in any combination of cash and tokens, providing the ability to adjust the liquidity of their investment according to their financial needs. This offers an additional degree of flexibility to property occupant, and also provides another use case for the property tokens.

In some cases, the tokenization system provides property occupants with the option to automatically use their dividend returns to purchase more tokens. This enables property occupants to accelerate their path to full ownership of the property. The system could also offer additional incentives for reinvestment, such as discounts or bonus tokens, to encourage tenants to reinvest their dividends.

FIG. 14 illustrates flexibility in tangible property access 1404. The tokenization system provides different levels of access to occupants with different amounts of tokens. For example, the tokenization system provides priority access offered to occupants with a larger quantity of ownership tokens.

If the property has shared amenities such as a gym, swimming pool, community space, or services such as premium parking spaces, occupants with more tokens could receive priority access to these amenities. In some cases, such priority access extends to property maintenance or repair services, where token-rich occupants receive quicker responses or priority scheduling.

FIG. 14 illustrates occupancy required exchange protection 1406. One significant advantage of accruing tokens could be rent protection, which safeguard occupants from future rent increases. As the cost of living and property values increase, rental costs often follow suit. However, the tokenization system offers degrees of immunity for occupants who have accumulated a certain number of tokens. This creates a more stable, predictable housing cost for the occupant, which can be especially beneficial in regions with rapidly increasing rent amounts.

FIG. 14 illustrates occupancy terms flexibility 1408. The tokenization system provides the occupants better lease terms. As described herein, the tokenization system generates contracts, such as lease agreements between the owner and the occupant. Over time, the tokenization system adjusts terms based on token ownership.

As tenants accumulate tokens and thus own a greater portion of the property, the tokenization system includes lease terms that provide occupants with more freedom. For instance, the tokenization system generates contracts that allow subletting a portion of the property, making certain modifications or renovations, or enabling other aspects of the lease that are typically inflexible for an occupant with a certain amount of tokens.

In some cases, the tokenization system provides tokenized incentives for occupants who improve and maintain the property. The tokenization system awards occupants with additional tokens when they make home improvements. Not only does this encourage occupants to invest in the property's upkeep and improvement, but it also allows them to increase their ownership stake in the home.

If a tenant makes an improvement, such as a significant improvement, to the property (e.g., renovating a bathroom, installing solar panels), the tokenization system determines an increased value of the property (such as by applying features of property valuation as described herein) and mint additional tokens to distribute to the occupant. This provides a tangible, direct benefit to the tenant for their contributions to the property's value and again incentivizes property improvements.

Moreover, the tokenization system establishes incentives for the tenant and property owner to work together, such as being good neighbors, ensuring property upkeep, sharing word-of-mouth to others. For example, the tenant also receives partial proceeds from other tenants in multiunit properties with progressive token ownership, and thus is incentivized to increase occupancy of other units.

FIG. 14 illustrates voting rights 1410 for occupants. The tokenization system enables occupants with an electronic option to submit voting for decisions on the property. The tokenization system enables the occupant to vote commensurate with their number of ownership tokens. This includes a vote in major property-related decisions, such as significant renovations, changes in property rules, or the selection of property management companies. Such a tokenization system democratizes the rental experience, allowing occupants to have a say in decisions that would directly impact their lives, proportionate to their investment in the property. This includes decisions about community events, shared amenities, or even local governance issues.

If a property were to be sold, the tokenization system enables token holding occupants the right of first refusal, allowing them to initiate purchase of the property outright. This preemptive purchase right not only provides occupants with a potential path to full property ownership, but also offers a measure of stability and predictability, as occupants would have the first opportunity to secure their housing situation in the event of a sale.

The tokenization system displays user interfaces that enable occupants to sell their tokens directly back to the property owner or on an open market. This flexibility provides a potential exit strategy for occupants who need to liquidate their investment quickly, offering a degree of financial security and flexibility not found in traditionally rental systems.

FIG. 14 illustrates cost sharing and reallocation 1412. The tokenization system provides a user interface and/or automatic tokenized exchange that enables occupants to pay for maintenance or renovation costs (such as by using a portion of the tokenized exchange and/or tokens held in the token repository).

In some tokenization systems, the number of tokens an occupant owns impacts their utility costs. For example, a percentage of the tokens owned could be applied as a credit towards utility bills, effectively reducing the cost of living in the property. In some cases, as the occupant accrues more tokens, the tokenization system initiates discounts received on property-related services such as cleaning, maintenance, or utilities.

FIG. 14 illustrates lower insurance premiums 1414. In traditional real estate markets, insurance providers often offer lower premiums to homeowners as compared to renters, based on the premise that homeowners are more likely to take care of their property and pose less risk. The tokenization system provides occupants that have accumulated tokens to progressively transition from being renters to becoming partial owners. This change in status provides them with a platform to lower insurance premiums. Insurers view token owning tenants as less risky due to their substantial investment in the property, and as such, the tokenization system initiates lower insurance rates for the occupant.

FIG. 14 illustrates improved credit 1416. The tokenization system provides regular and successful payments of rent and token purchases to a credit bureau. These token transactions are reported to credit bureaus that reflect favorably on a person's credit report. Over time, this consistent token purchase record improves an occupant's credit scores.

### Intermediary Submitting Tokens for Use

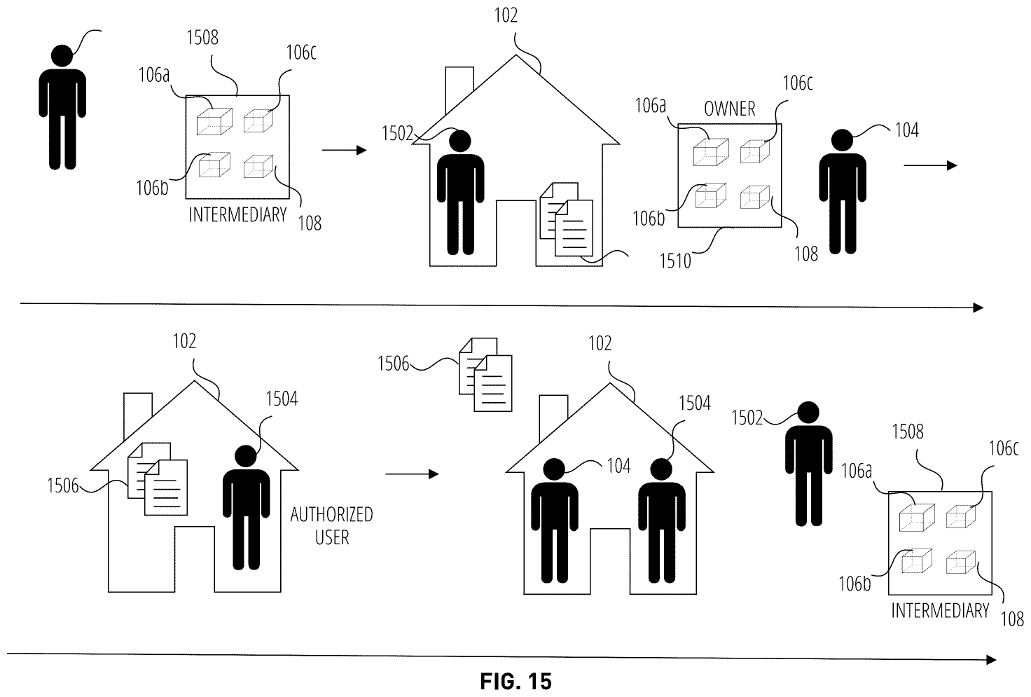

FIG. 15 illustrates an intermediary submitting tokens for use of a home, according to some examples. In some cases, an intermediary 1502 purchases all outstanding tokens for a tokenized property from the current fractional owners of a home 102. In other cases, the intermediary purchases all tokens 106 that have a value equal to (or at least sufficient tokens for use of) the home 102 by transmitting the tokens into the intermediary's token storage. The intermediary now owns 100% of the tokens necessary for right to the property.

In some cases, the intermediary submits the tokens they own to the tokenization system as a deposit to access usage rights of the property for a set period of time. The tokenization system transfers the tokens from the intermediary to a holding account, granting the intermediary temporary usage rights. In some cases, the tokenization system sends the tokens to the token storage 1510 of the home owner 104.

The intermediary and/or the tokenization system finds a tenant 1504 and the intermediary and/or the tokenization system has the tenant sign a lease agreement 1506 to rent the property. As the tenant pays rent, the tokenization system automatically disburses portions of the rent payment to the original property owners and the intermediary based on predefined percentages. For example, 80% of the rent could go to the owners and 20% to the intermediary.

At the end of the agreed usage period, all tokens are transferred from the holding account back to the intermediary. The property reverts fully to the original owners. If the tenant wishes to continue occupying the property, the tenant now pays rent directly to the owners as per a new lease agreement 1506. The intermediary retains the income they made during the period they had usage rights.

Machine Learning Models to Optimize and/or Forecast Value of Tokens for Asset Owner and Token Owners While Leveraging Blockchain to Regulate Resource Allocation Governance

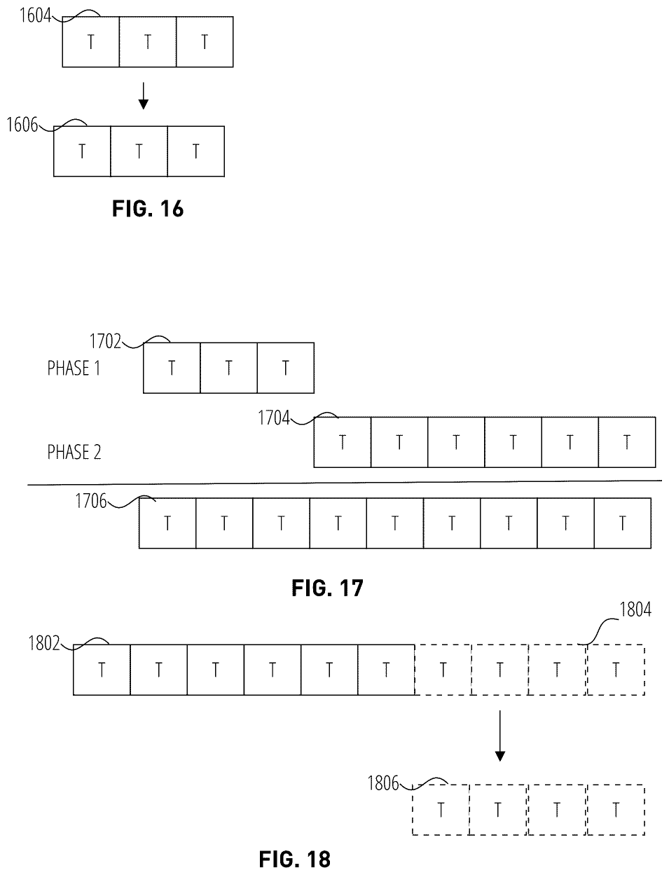

FIG. 16 to FIG. 20 illustrate examples of different modes for a decentralized protocol involving tokens for resource allocation, according to some examples. FIG. 16 illustrates a first mode for a conventional loan, according to some examples. In this mode, there is no collateral provided for the loan. The proposed asset 1604 for the loan and the loan amount 1606 are represented by 3 tokens (T T T). The loan amount is equivalent to the value of the proposed asset 1604.

The first mode represents a traditional loan scenario, but with the asset tokenized to provide additional benefits to lenders beyond simple interest repayment. The tokenization provides more flexibility, such as receiving returns on the tokens in the form of interest, benefits from market appreciation if the token values increase on the open market, and/or receiving a buyback guarantee from the asset owner to repurchase the tokens at a certain price at a later time.

FIG. 17 illustrates a second mode for another loan without collateral, according to some examples. The proposed asset is tokenized into a number of tokens (represented by T's). The tokenization system divides the asset plan into 2 phases and corresponding tokens 1702 and 1704. At each phase, the tokenization system enables transfer of the tokens from the property owner to recipients.

In some cases, the phases correspond to phases of development. Phases can include planning where market research, site analysis, financial analysis and/or conceptual design is performed. Another phase can include entitlement and approvals, where zoning and permits are obtained, the environment is studied and reviewed, community engagement is measured, design is developed, and/or the like.

In some cases, another phase includes preconstruction where architectural design, engineering, bidding, contractor selection, cost estimation, and/or the like is performed. In some cases, the next phase is construction including site preparation, foundation and infrastructure construction, mechanical, electrical, and plumbing installation, interior finishes, and/or the like.

In some cases, the following stage includes completing and handover including final inspections, quality assurance, handover to owners or tenants, and/or the like. In some cases, the final phase includes post-construction and operations including property management, marketing, leasing, agreements, asset management, and/or the like.

For example, in phase 1, the tokenization system enables transfer of 3 tokens during the first phase to recipients, the first phase being up to construction. Thus, new token recipients can buy/sell tokens during asset development (before it is completed) and/or within any phase.

The tokenization system can provide a risk tolerance, target appreciation expectation, and/or interest return expectation using a machine learning model based on training and data as further described herein. After acquiring tokens, the tokenization system provides returns and/or negates the need for interest payments based on dividends, such as a portion of the proceeds from the home being allocated to the token holder.

New token owners can hold tokens until the asset has been completed whereby the tokens can benefit from return on tokens (when asset is utilized) and/or based on market appreciation. In some cases, the tokenization system projects an expected change in market appreciation at least partially based on when they purchased (e.g., a machine learning model can factor in the earlier the purchase, the higher the expected change in value).

In some cases, the tokenization system provides a buyback guarantee from asset owner and/or the ability for tokens to be used toward of completed asset. For example, for the second phase, the recipients can transmit all tokens in the second phase, which is a phase when the property has been completed and tenants of the property are paying proceeds. As such, the recipients can over time gain all tokens 1706 for full ownership of the property.

FIG. 18 illustrates a third mode regarding collateral for a loan, according to some examples. In some cases, the tokenization system enables a loan amount for a portion of the value. For example, the asset is valued as both the total number of tokens 1802 and 1804.

However, the tokenization system only provides a loan value of a certain percentage or amount based on the total value. For example, the tokenization system only provides loans for 40% of the total value (e.g., 10 tokens total, only 4 tokens 1804 which is equivalent for a loan). The tokenization system provides the owner with a 4 token loan 1806, enabling the property owner to gain the full benefit of the property's appreciation while having additional tokens to loan or sell on the open market to other recipients.

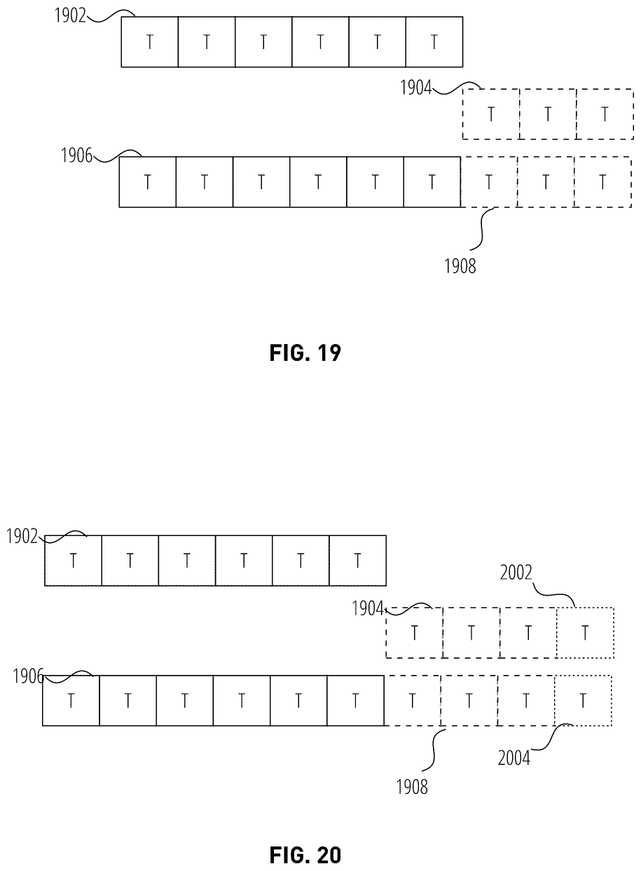

FIG. 19 illustrates a third mode illustrating token relocation based on appreciation in value of the property, according to some examples. In some cases, an existing asset has already been tokenized into 6 tokens 1902. The 6 tokens are sold into the market and purchase by recipients (recipient tokens 1906). As tokens are sold to recipients, these new token owners can benefit from return on such tokens, such as from market appreciation of token values or sudden changes in values. For example, the asset can appreciate or depreciate over time.

In some cases, the additional tokens generated over time 1904, such as through appreciation and/or through proceeds can be provided and distributed to the current token holders. As such, the total value of the home has appreciated over time to be valued as the combination of tokens 1906 and 1908.

FIG. 20 illustrates a forth mode illustrating token relocation based on a sudden change in value of the property, according to some examples. In some cases, a modification or sudden damage occurs on the property. The tokenization system identifies such a sudden change in value and identifies that the change is equivalent to one token 2002. The tokenization system divides the one token 2002 and distributes to each token holder according to their fractional ownership. As such, the total value of the property is now the tokens 1906, the tokens 1908, and token 2004.

### Machine Architecture

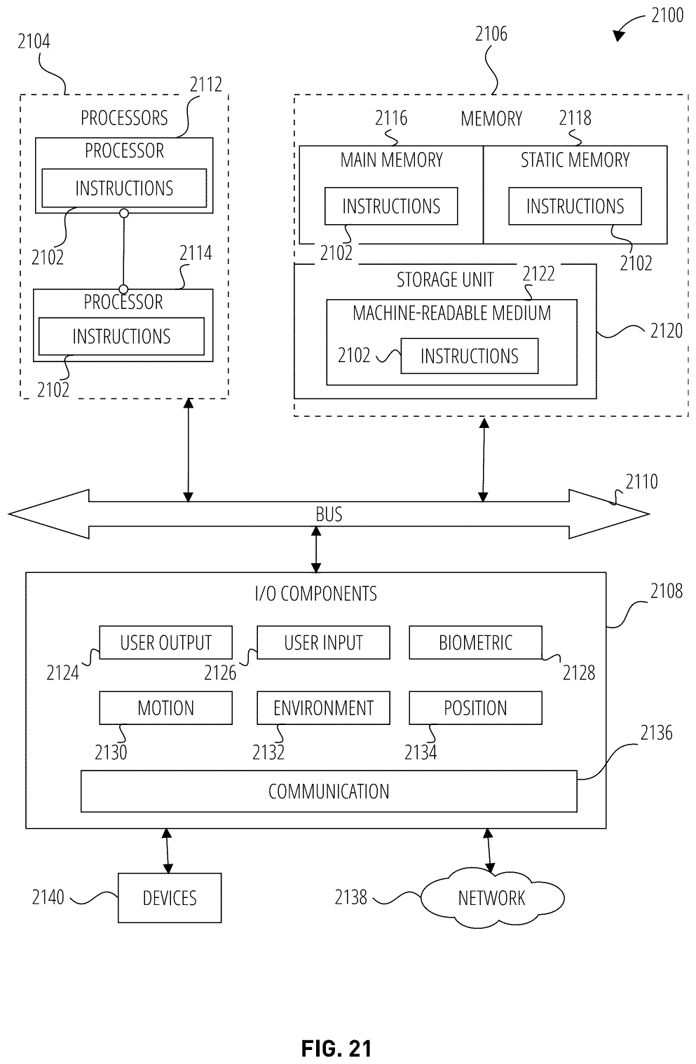

FIG. 21 is a diagrammatic representation of the machine 2100 within which instructions 2102 (e.g., software, a program, an application, an applet, an app, or other executable code) for causing the machine 2100 to perform any one or more of the methodologies discussed herein may be executed. For example, the instructions 2102 may cause the machine 2100 to execute any one or more of the methods described herein. The instructions 2102 transform the general, non-programmed machine 2100 into a particular machine 2100 programmed to carry out the described and illustrated functions in the manner described. The machine 2100 may operate as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2102, sequentially or otherwise, that specify actions to be taken by the machine 2100. Further, while a single machine 2100 is illustrated, the term “machine” shall also be taken to include a collection of machines that individually or jointly execute the instructions 2102 to perform any one or more of the methodologies discussed herein. The machine 2100, for example, may comprise a user system or any one of multiple server devices forming part of the server system. In some examples, the machine 2100 may also comprise both client and server systems, with certain operations of a particular method or algorithm being performed on the server-side and with certain operations of the particular method or algorithm being performed on the client-side.

The machine 2100 may include processors 2104, memory 2106, and input/output (I/O) components 2108, which may be configured to communicate with each other via a bus 2110. In an example, the processors 2104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 2112 and a processor 2114 that execute the instructions 2102. The term “processor” is intended to include multi-core processors that may comprise two or more independent processors (sometimes referred to as “cores”) that may execute instructions contemporaneously. Although FIG. 21 shows multiple processors 2104, the machine 2100 may include a single processor with a single-core, a single processor with multiple cores (e.g., a multi-core processor), multiple processors with a single core, multiple processors with multiples cores, or any combination thereof.

The memory 2106 includes a main memory 2116, a static memory 2118, and a storage unit 2120, both accessible to the processors 2104 via the bus 2110. The main memory 2106, the static memory 2118, and storage unit 2120 store the instructions 2102 embodying any one or more of the methodologies or functions described herein. The instructions 2102 may also reside, completely or partially, within the main memory 2116, within the static memory 2118, within machine-readable medium 2122 within the storage unit 2120, within at least one of the processors 2104 (e.g., within the processor's cache memory), or any suitable combination thereof, during execution thereof by the machine 2100.

The I/O components 2108 may include a wide variety of components to receive input, provide output, produce output, transmit information, exchange information, capture measurements, and so on. The specific I/O components 2108 that are included in a particular machine will depend on the type of machine. For example, portable machines such as mobile phones may include a touch input device or other such input mechanisms, while a headless server machine will likely not include such a touch input device. It will be appreciated that the I/O components 2108 may include many other components that are not shown in FIG. 21. In various examples, the I/O components 2108 may include user output components 2124 and user input components 2126. The user output components 2124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 2126 may include alphanumeric input components (e.g., a keyboard, a touch screen configured to receive alphanumeric input, video input (e.g., camera), peer-to-peer input (e.g., chatbot), a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 2108 may include biometric components 2128, motion components 2130, environmental components 2132, or position components 2134, among a wide array of other components. The motion components 2130 include acceleration sensor components (e.g., accelerometer), gravitation sensor components, rotation sensor components (e.g., gyroscope).

The environmental components 2132 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 2134 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2108 further include communication components 2136 operable to couple the machine 2100 to a network 2138 or devices 2140 via respective coupling or connections. For example, the communication components 2136 may include a network interface component or another suitable device to interface with the network 2138. In further examples, the communication components 2136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2140 may be another machine or any of a wide variety of peripheral devices (e.g., a peripheral device coupled via a USB).

Moreover, the communication components 2136 may detect identifiers or include components operable to detect identifiers. For example, the communication components 2136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 2136, such as location via Internet Protocol (IP) geolocation, location via Wi-Fi® signal triangulation, location via detecting an NFC beacon signal that may indicate a particular location, and so forth.

The various memories (e.g., main memory 2116, static memory 2118, and memory of the processors 2104) and storage unit 2120 may store one or more sets of instructions and data structures (e.g., software) embodying or used by any one or more of the methodologies or functions described herein. These instructions (e.g., the instructions 2102), when executed by processors 2104, cause various operations to implement the disclosed examples.

The instructions 2102 may be transmitted or received over the network 2138, using a transmission medium, via a network interface device (e.g., a network interface component included in the communication components 2136) and using any one of several well-known transfer protocols (e.g., hypertext transfer protocol (HTTP)). Similarly, the instructions 2102 may be transmitted or received using a transmission medium via a coupling (e.g., a peer-to-peer coupling) to the devices 2140.

### Software Architecture

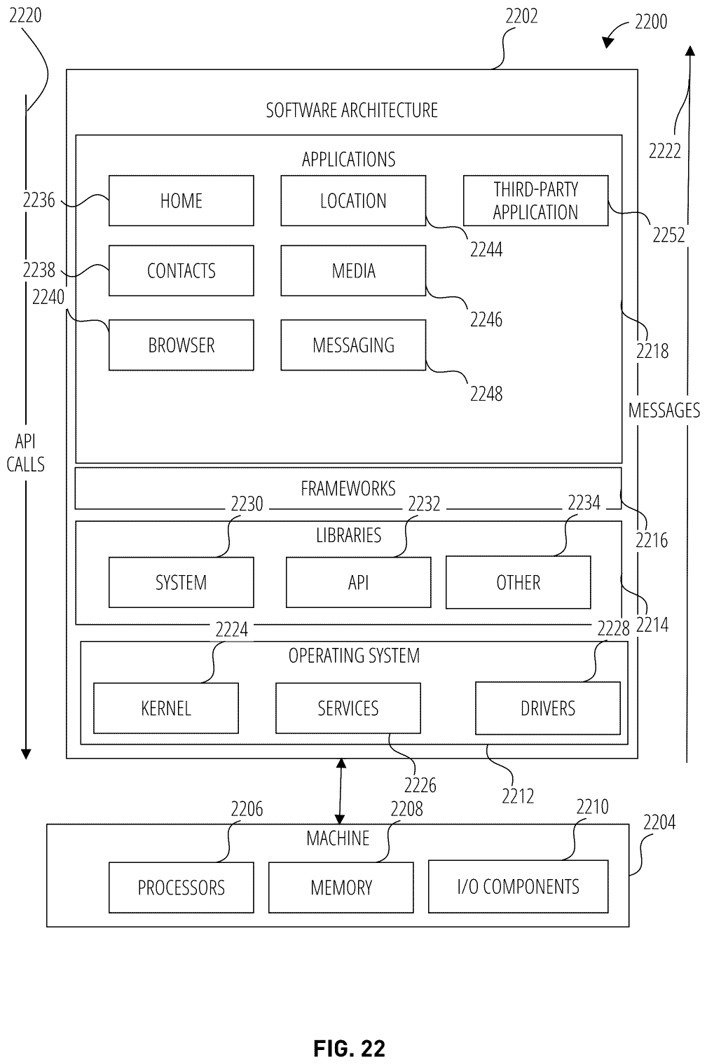

FIG. 22 is a block diagram 2200 illustrating a software architecture 2202, which can be installed on any one or more of the devices described herein. The software architecture 2202 is supported by hardware such as a machine 2204 that includes processors 2206, memory 2208, and I/O components 2210. In this example, the software architecture 2202 can be conceptualized as a stack of layers, where each layer provides a particular functionality. The software architecture 2202 includes layers such as an operating system 2212, libraries 2214, frameworks 2216, and applications 2218. Operationally, the applications 2218 invoke API calls 2220 through the software stack and receive messages 2222 in response to the API calls 2220.

The operating system 2212 manages hardware resources and provides common services. The operating system 2212 includes, for example, a kernel 2224, services 2226, and drivers 2228. The kernel 2224 acts as an abstraction layer between the hardware and the other software layers. For example, the kernel 2224 provides memory management, processor management (e.g., scheduling), component management, networking, and security settings, among other functionalities. The services 2226 can provide other common services for the other software layers. The drivers 2228 are responsible for controlling or interfacing with the underlying hardware. For instance, the drivers 2228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 2214 provide a common low-level infrastructure used by the applications 2218. The libraries 2214 can include system libraries 2230 (e.g., C standard library) that provide functions such as memory allocation functions, string manipulation functions, mathematic functions, and the like. In addition, the libraries 2214 can include API libraries 2232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 2214 can also include a wide variety of other libraries 2234 to provide many other APIs to the applications 2218.

The frameworks 2216 provide a common high-level infrastructure that is used by the applications 2218. For example, the frameworks 2216 provide various graphical user interface (GUI) functions, high-level resource management, and high-level location services. The frameworks 2216 can provide a broad spectrum of other APIs that can be used by the applications 2218, some of which may be specific to a particular operating system or platform.

In an example, the applications 2218 may include a home application 2236, a contacts application 2238, a browser application 2240, a location application 2244, a media application 2246, a messaging application 2248, and a broad assortment of other applications such as a third-party application 2252. The applications 2218 are programs that execute functions defined in the programs. Various programming languages can be employed to create one or more of the applications 2218, structured in a variety of manners, such as object-oriented programming languages (e.g., Objective-C, Java, or C++) or procedural programming languages (e.g., C or assembly language). In a specific example, the third-party application 2252 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2252 can invoke the API calls 2220 provided by the operating system 2212 to facilitate functionalities described herein.

### Machine-Learning Pipeline

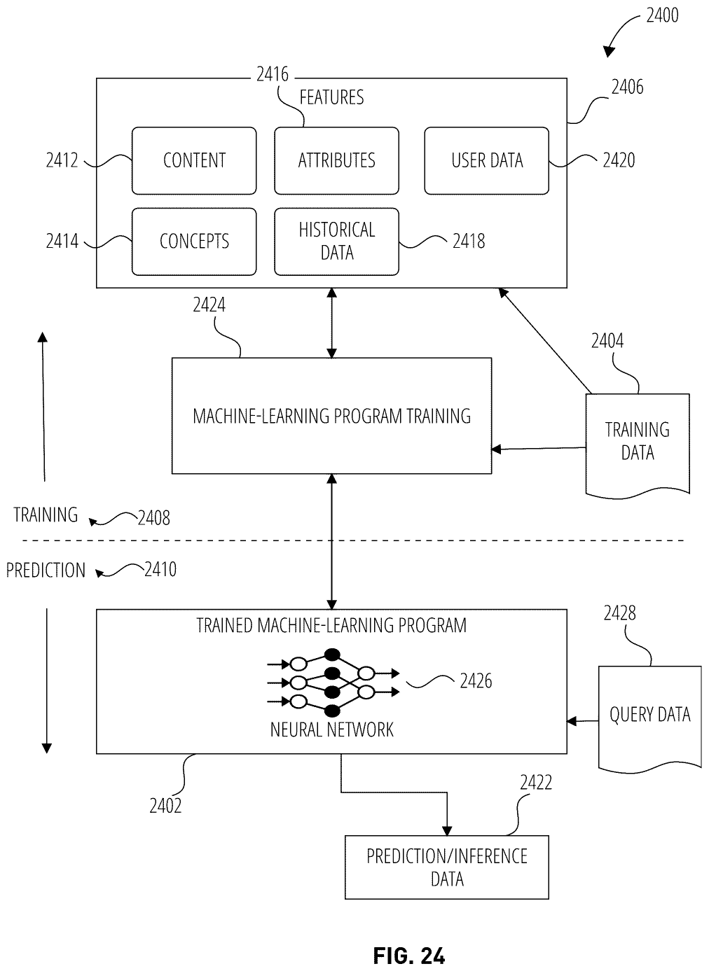

FIG. 24 is a flowchart depicting a machine-learning pipeline 2400, according to some examples. The machine-learning pipelines 2400 may be used to generate a trained model, for example the trained machine-learning program 2402 of FIG. 24, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

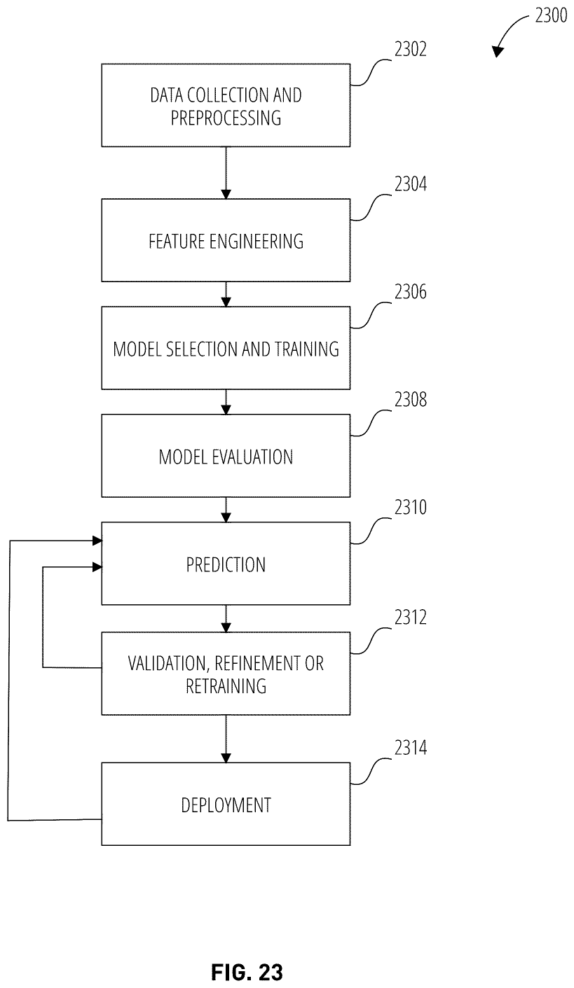

Generating a trained machine-learning program 2402 may include multiple types of phases that form part of the machine-learning pipeline 2400, including for example the following phases 2300 illustrated in FIG. 23:
Data collection and preprocessing 2302: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 2304: This may include selecting and transforming the training data 2404 to create features that are useful for predicting the target variable. Feature engineering may include (1) receiving features 2406 (e.g., as structured or labeled data in supervised learning) and/or (2) identifying features 2406 (e.g., unstructured or unlabeled data for unsupervised learning) in training data 2404.
Model selection and training 2306: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 2308: This may include evaluating the performance of a trained model (e.g., the trained machine-learning program 2402) on a separate testing dataset. This can help determine if the model is overfitting or underfitting and if it is suitable for deployment.
Prediction 2310: This involves using a trained model (e.g., trained machine-learning program 2402) to generate predictions on new, unseen data.
Validation, refinement or retraining 2312: This may include updating a model based on feedback generated from the prediction phase, such as new data or user feedback.
Deployment 2314: This may include integrating the trained model (e.g., the trained machine-learning program 2402) into a larger system or application, such as a web service, mobile app, or IoT device. This can involve setting up APIs, building a user interface, and ensuring that the model is scalable and can handle large volumes of data.

FIG. 24 illustrates two example phases, namely a training phase 2408 (part of the model selection and trainings 2306) and a prediction phase 2410 (part of prediction 2310). Prior to the training phase 2408, feature engineering 2304 is used to identify features 2406. This may include identifying informative, discriminating, and independent features for the effective operation of the trained machine-learning program 2402 in pattern recognition, classification, and regression. In some examples, the training data 2404 includes labeled data, which is known data for pre-identified features 2406 and one or more outcomes.

Each of the features 2406 may be a variable or attribute, such as individual measurable property of a process, article, system, or phenomenon represented by a data set (e.g., the training data 2404). Features 2406 may also be of different types, such as numeric features, strings, vectors, matrices, encodings, and graphs, and may include one or more of content 2412, concepts 2414, attributes 2416, historical data 2418 and/or user data 2420, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 2408, the machine-learning pipeline 2400 uses the training data 2404 to find correlations among the features 2406 that affect a predicted outcome or prediction/inference data 2422.

With the training data 2404 and the identified features 2406, the trained machine-learning program 2402 is trained during the training phase 2408 during machine-learning program training 2424. The machine-learning program training 2424 appraises values of the features 2406 as they correlate to the training data 2404. The result of the training is the trained machine-learning program 2402 (e.g., a trained or learned model).

Further, the training phase 2408 may involve machine learning, in which the training data 2404 is structured (e.g., labeled during preprocessing operations), and the trained machine-learning program 2402 implements a relatively simple neural network 2426 capable of performing, for example, classification and clustering operations. In other examples, the training phase 2408 may involve deep learning, in which the training data 2404 is unstructured, and the trained machine-learning program 2402 implements a deep neural network 2426 that is able to perform both feature extraction and classification/clustering operations.

A neural network 2426 may, in some examples, be generated during the training phase 2408, and implemented within the trained machine-learning program 2402. The neural network 2426 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 2426 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 2426 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 2408, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 2426 is iteratively trained by adjusting model parameters to minimize a specific loss function or maximize a certain objective. The system can continue to train the neural network 2426 by adjusting parameters based on the output of the validation, refinement, or retraining block 2312, and rerun the prediction 2310 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 2426 even after deployment 2314 of the neural network 2426. The neural network 2426 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 2410, the trained machine-learning program 2402 uses the features 2406 for analyzing query data 2428 to generate inferences, outcomes, or predictions, as examples of a prediction/inference data 2422. For example, during prediction phase 2410, the trained machine-learning program 2402 is used to generate an output. Query data 2428 is provided as an input to the trained machine-learning program 2402, and the trained machine-learning program 2402 generates the prediction/inference data 2422 as output, responsive to receipt of the query data 2428. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 2402 may be a generative AI model. Generative Al is a term that may refer to any type of artificial intelligence that can create new content from training data 2404. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 2422 that is output include trend assessment and predictions, translations, summaries, image or video recognition and categorization, natural language processing, face recognition, user sentiment assessments, advertisement targeting and optimization, voice recognition, or media content generation, recommendation, and personalization.

Usage Cases for Tokenization, Ownership, Use, and/or the Like

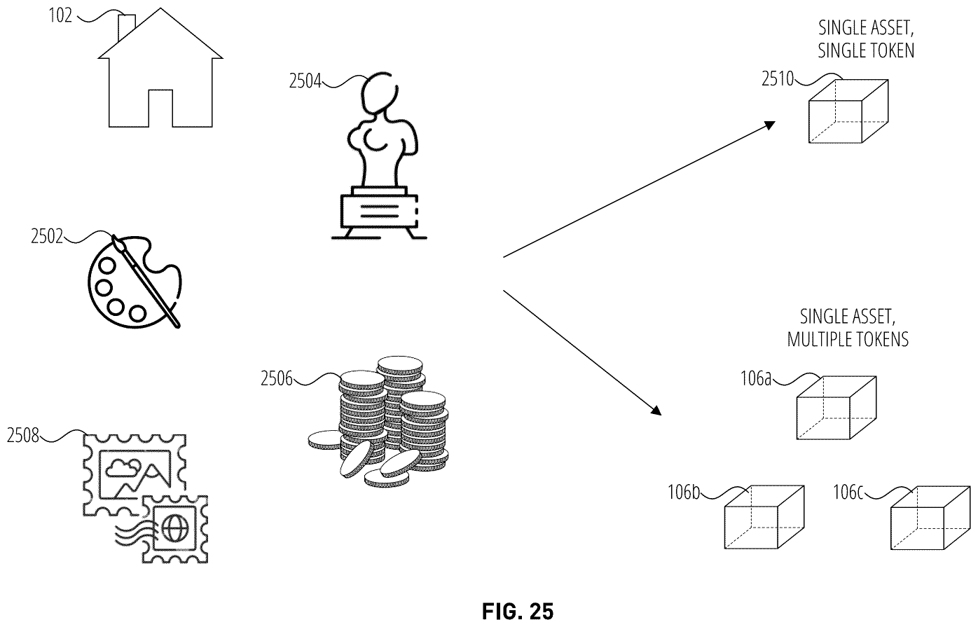

FIG. 25 illustrates tokenization of an asset as a whole, according to some examples. In some cases, a real world asset is not divided into parts by the tokenization system. For example, a home 102 is tokenized as a whole and not divided into different rooms. In some cases, the tokenization system tokenizes assets that are not easily dividable without changing the asset itself, such as a sculpture 2504, a painting 2502, a stamp in a stamp collection 2508, a coin in a rare coin collection 2506, and/or the like.

In some cases, the tokenization system generates and/or mints a single token 2510 corresponding to ownership or usage rights for the individual asset. In other cases, the tokenization system generates and/or mints multiple tokens 106a, 106b, 106c representing fractional ownership and/or different usage rights for the individual asset.

As users gain ownership and/or usage rights for the individual asset, users can start utilizing the asset as per the agreement and/or contractual terms (as further described herein).

In some cases, asset owners can jointly tokenize assets. For example, the artist and sculptor can jointly tokenize their paintings and sculptures. The joint assets can be tokenized either into a single token or multiple tokens. In some cases, the individual assets are valuated and tokens are assigned respectively. In other cases, a single token provides ownership and/or usage of the joint assets.

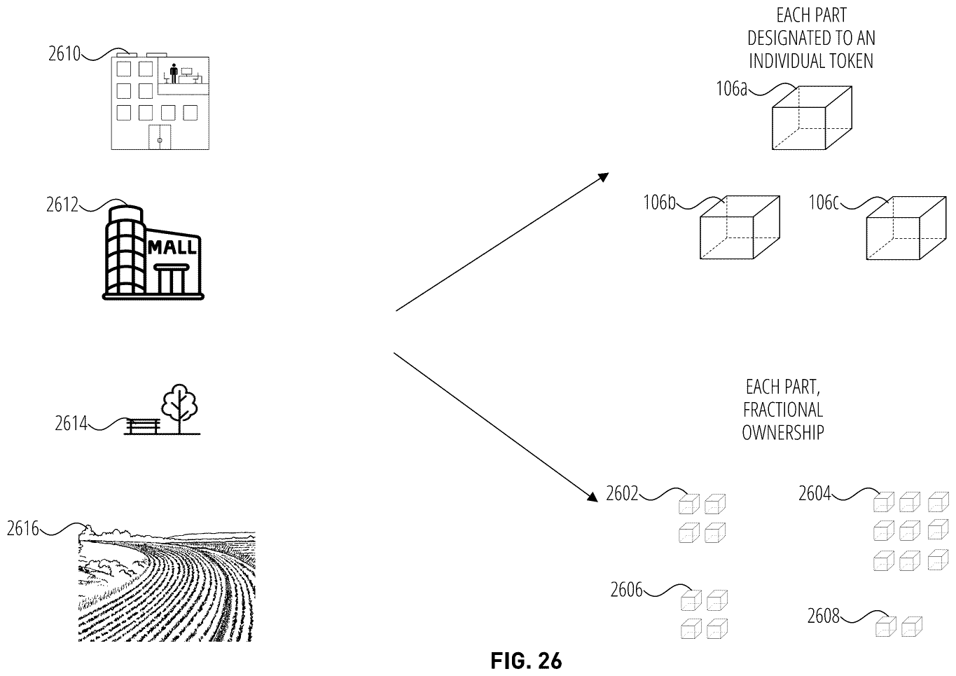

FIG. 26 illustrates tokenization of an asset that is divisible into parts, according to some examples. The tokenization system can divide an asset, such as a building 2610, a mall 2612, a park 2614, farm land 2616, into parts and tokenize individual parts for use and/or ownership. For example, a building can be divided into apartments, a mall can be divided into sections for stores, farm land divided into parcels, and/or the like.

In some cases, the tokenization system generates an individual usage and/or ownership token for each divisible part, such as token 106a for a first apartment unit, token 106b for a second apartment unit, and 106c for a third apartment unit. In other cases, the tokenization system generates multiple tokens for each part. such as tokens 2602 for a first store front, tokens 2604 for a second store front, tokens 2606 for a third store front, tokens 2608 for a fourth store front and/or the like. In some cases, the amount of tokens for each part is determined using the valuation methods and processes as further described herein.

In some cases, the tokenization system identifies divisible parts based on third party data, such as data on the number of units in an apartment building retrieved from a real estate or government website. In some cases, the tokenization system applies a machine learning model that is trained to automatically determine divisible portions of a particular asset. For example, the machine learning model can receive as input an address of an asset, a type of asset (such as if the asset type indicates a divisible number of parts such as a duplex), input from the asset owner of characteristics of the asset, and/or the like (other inputs to the machine learning model further described herein).

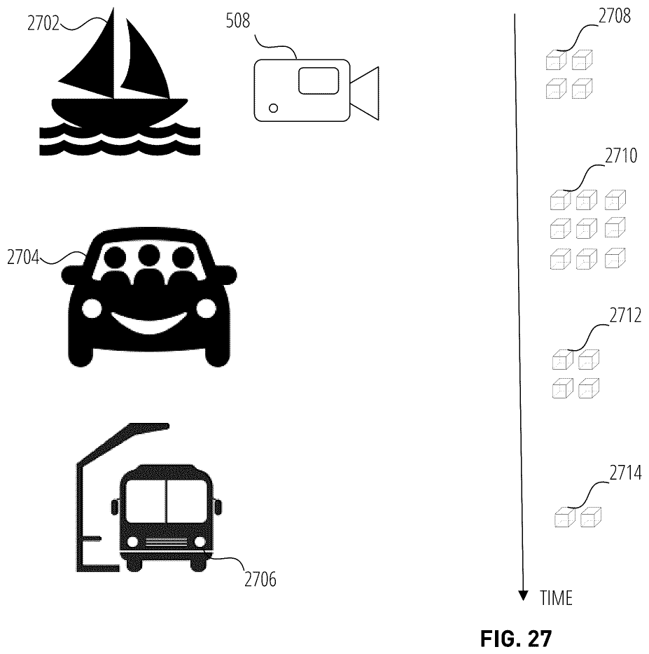

FIG. 27 illustrates tokenizing ownership and/or usage across time, according to some examples. In some cases, the tokenization system can tokenize an asset, such as a boat 2702, equipment 508, car 2704, public transportation 2706, and/or the like over time. The tokenization system applies ownership and/or usage rights over time. For example, a boat 2702 can be rented throughout the year for the use in boat tours.

The tokenization system can generate tokens according to the time and/or time frame desired for ownership and/or usage. For example, the tokenization system determines that boat tours are in demand in certain parts of the year but not in others. The tokenization system can apply the valuation methods and processes as further described herein to value the ownership and/or usage for particular time periods. For example, the time frame for tokens 2710 are in high demand, and thus more tokens are required for ownership and/or usage for these time slots, whereas the time periods for tokens 2708, 2712, and 2714 are in less demand and thus less tokens are minted for these time periods.

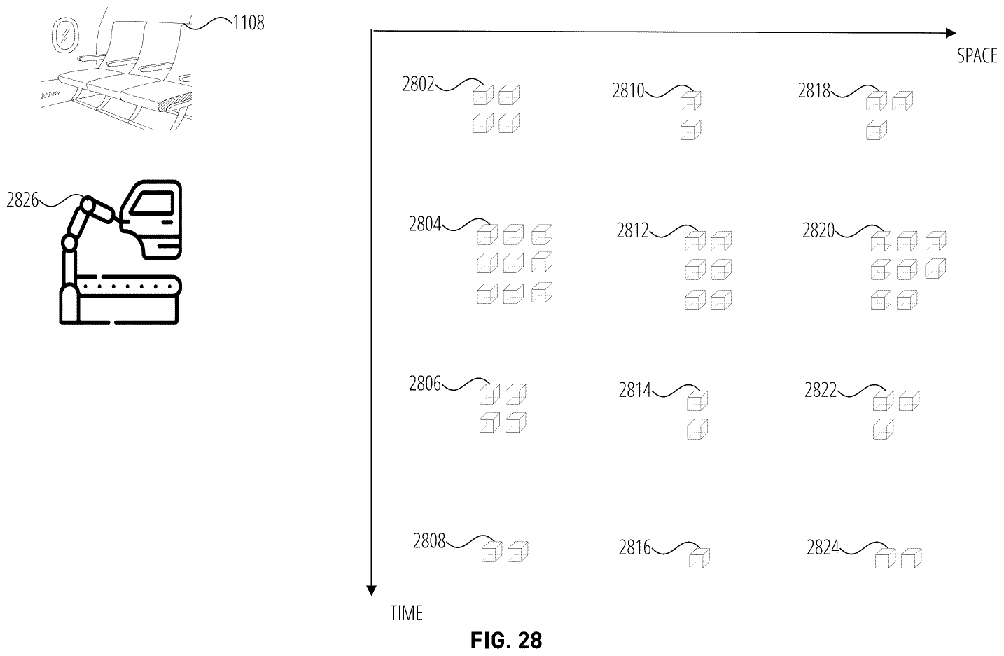

FIG. 28 illustrate tokenizing ownership and/or usage across time and parts, according to some examples. In some cases, the tokenization system tokenizes an asset across time and space. For example, the tokenization system divides an airplane 1108 into multiple seats or a multiple factory production lines in a factory 2826.

An airplane can have tens or hundreds of seats, each of which could be tokenized. In some cases, a group of seats can be tokenized, such as 4 seats for a family of 4. Such tokens can be tied to a particular airplane or to an airline with a fleet of airplanes.

In some cases, the tokenization system tokenizes ownership and/or usage across multiple factors, such as time and parts. It is appreciated that the tokenization system can tokenize an asset across one or more other factors, such as time and location, time parts and location, and/or the like.

As noted herein, the tokenization system can determine a valuation for the token based on these factors. In FIG. 28, the tokenization system determines that the certain seats at a particular time frame corresponding to tokens 2804 and 2820 are the highest in demand or highest in cost. As such, the more tokens are minted for the seats and time corresponding to tokens 2804 and 2820 than that for tokens 2802, 2810, 2818, 2812, 2806, 2814, 2822, 2808, 2816, and 2824.

In some cases, a factory with multiple production lines can tokenize each production line over different periods of time. Ownership of Tokens allow for the usage of associated production lines and collection of proceeds from the product line output. In some cases, a livestock production facility can tokenize each production line and across multiple cycles within a calendar year and offer those tokens to individual operators. These operators can make use of the facility for their own production and/or further offer the production line to other operators who could make use of the facility.

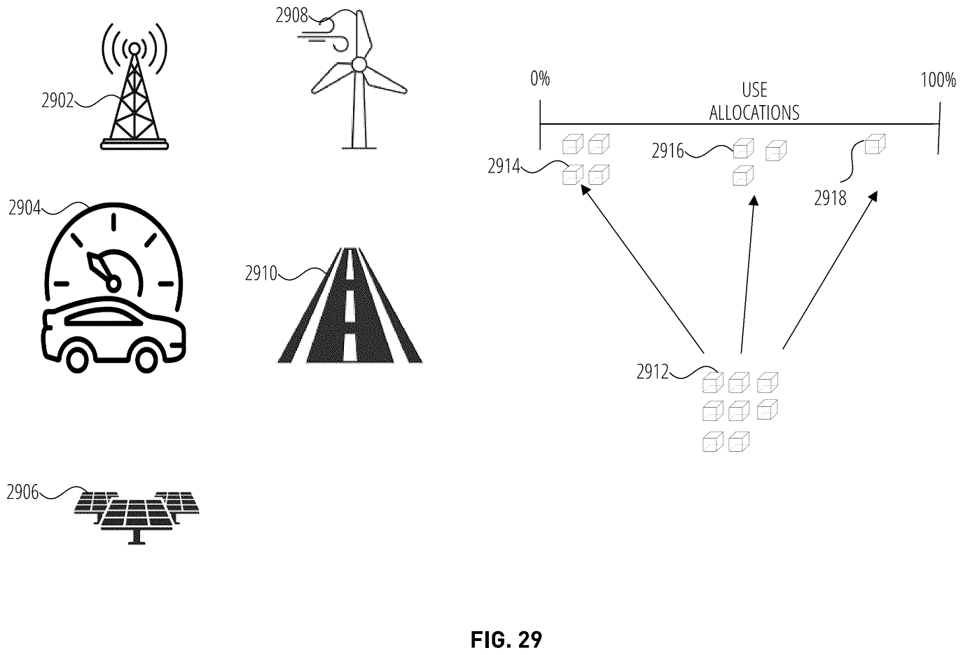

FIG. 29 illustrates tokenization for use allocations, according to some examples. The tokenization system can tokenize use allocations for assets. The tokenization system can tokenize cellphone towers 2902 such as based on data bandwidth usage. The tokenization system can tokenize amount of electricity generation by a wind turbine 2908 or solar farms 2906. The tokenization system can tokenize automobiles 2904 based on mileage. The tokenization system can tokenize use of roads 2910, such as an amount of traffic or length of travel.

Use allocations can be uniform across use, such as allocating the same amount of tokens for use of an automobile from 0-10 miles, 10-20 miles, 20-30 miles, etc. As shown in FIG. 29, use allocations can be different across use allocations. The automobile can be equivalent to a total token group 2912. However the use of the automobile may be of a higher value when the automobile is new. As such, the first group of miles for the automobile may be worth more tokens, such as tokens 2914, than when the automobile is at the middle of its lifespan, such as tokens 2916, or the end of its lifespan, such as token 2918.

In some cases, the tokenization system tokenizes cellphone towers (e.g., data use), automobile or farm equipment (e.g., mileage), oil wells, solar farms, wind turbines, other energy sources, mining rights, water rights, fishing quotas, bridges, toll roads, public transport, locations with services (e.g., fitness center, copy center, restaurant), and/or the like.

The tokenization system can tokenize an internet provider based on a provided bandwidth. The tokenization system can generate tokens representative of portions of bandwidth usage and provide such tokens to a large user base or virtual providers. The owners of these tokens can then use the associated bandwidth or sell the bandwidth to other users. A geographically diverse shared electricity grid can also tokenize its production of electricity and offer tokens to individual electricity producers that best meet the demands of their customers. Both these examples demonstrate the ability of the tokenization system to improve utilization of temporal assets that would be lost if not used immediately.

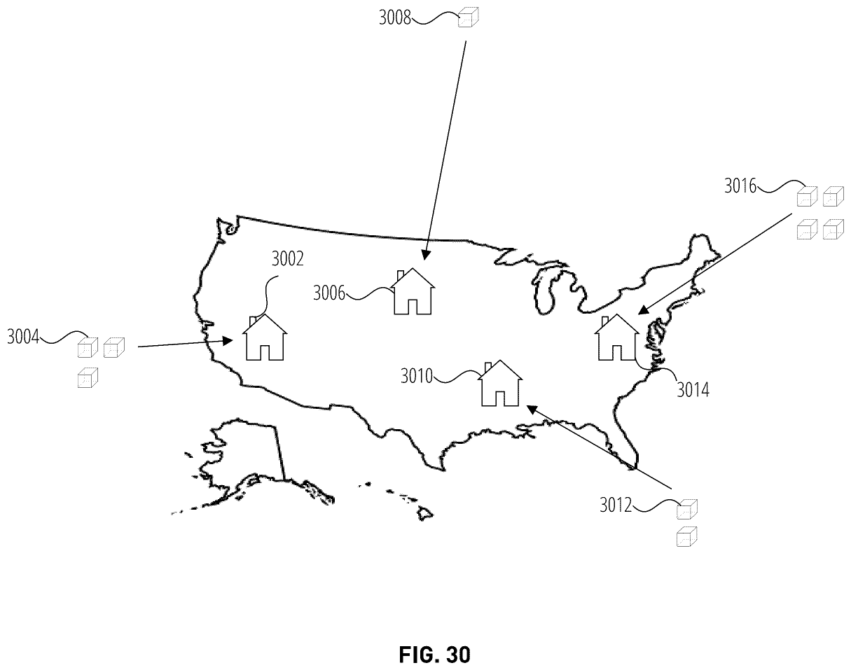

FIG. 30 illustrates token generation based on location, according to some examples. In some cases, the tokenization system tokenizes homes 3002, 3006, 3010, and 3014. Depending on the location of the home, the home may be valued differently. The tokenization system takes into consideration location, and/or other characteristics as described further herein in the valuation model, to determine a number of tokens to generate for the home. For example, home 3002 is provided with 3 tokens 3004, home 3006 is provided with 1 token 3008, home 3010 is provided with 2 tokens 3012, and home 3014 is provided with 4 tokens 3016.

In some cases, the tokenization system tokenizes medical facilities, clinics, wellness centers, companies (legal practices, accounting firms, consulting firms, research centers, etc.), and/or the like based on at least location.

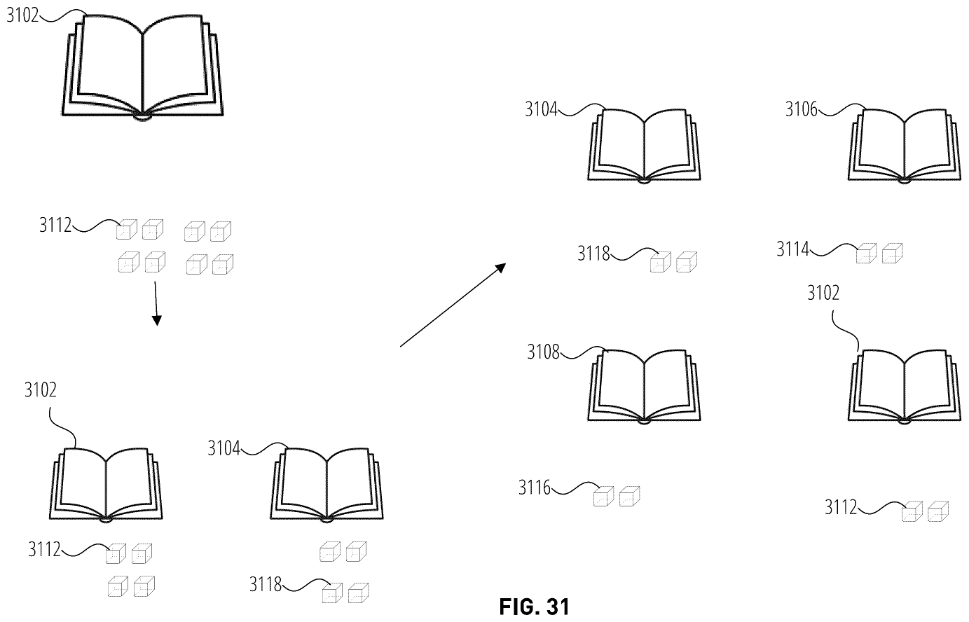

FIG. 31 illustrates token generation for copies of goods, according to some examples. In some cases, the tokenization system tokenizes copies of goods, such as artwork, creative works, books, movies, designs, architectural plans, educational content, music, software, formulas, recipes, advertisements, intellectual property, machine learning models, virtual objects (objects in virtual reality, augmented reality, mixed reality, etc), in-game items, in-application items, pharmaceuticals, and/or the like.

In some cases, as more copies are made, the more tokens are generated and/or the reduction of value for each token. For example, a book 3102 without any copies can be equivalent to 8 tokens 3112. The tokenization system can generate a first copy of the book 3104 and with the generated first copy, divide the number of tokens equally (e.g., 3112, 3114) between the original book 3102 and the first copy 3104. As such, the owner can decide how many copies to generate and how granular the owner desires the tokens and asset to be sold. In the next step, second copy 3106 and third copy 3108 are generated, and the tokenization system generates tokens 3118 and 3116 respectively. As shown in FIG. 31, after there are 4 copies in existence, the value for each book is reduced from 8 tokens down to 2 tokens each.

Although particular examples are described herein, such as a home being non-divisible and tokenized, it is appreciated that the example assets described herein can be applied to other types of tokenization. For example, the home 102 can be tokenized for usage across time, such as a short term rental.

The previous use cases can be combined whereby different features can be obtained from each case. This allows for a large amount of flexibility according to the underlying assets and intended usage. For example, the tokenization system can use the same tokens for different assets enabling flexibility in exchange of assets. For example, the tokenization system can apply tokens from a token owner issued by the same asset owner for use of different assets even if the assets are different or have different usage models.

Assets can be owned by a single or multiple asset owners. An asset owner can have a single or multiple assets. Assets can be used by a single or multiple tenants simultaneously. Asset usage can span a single or multiple time periods. A tenant may be allowed to utilize the asset for themselves only or offer it to be utilized by others. Intermediaries can borrow Tokens and acquire some asset ownership rights to offer the assets to other tenants. Asset utilization returns are shared with all token owners and potentially a portion of tenant returns. The asset itself can be made eligible for ownership if enough tokens are owned by a tenant.

As further described herein, the ownership and/or usage can be on a first come first serve basis, the tokenization system can implement a bidding auction whereby users can bid tokens and/or payments for a certain ownership or usage of an asset, and/or the like.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a digital physical property title for a physical property from a physical property owner; identifying a value of the physical property; generating a plurality of virtual asset units corresponding to the value of the physical property based on the value and a token value for each digital token, each virtual asset unit representing a fractional ownership interest in the physical property; transmitting the generated virtual asset units to a virtual asset storage associated with the physical property owner; and periodically, during a physical property utilization period for a physical property user: receiving an indication of a virtual asset relocation from the physical property user utilizing the physical property; identifying a first portion of the virtual asset relocation transmitted to the physical property owner; determining a number of virtual asset units corresponding to a second portion of the virtual asset relocation based on the first portion; and transferring the number of virtual asset units corresponding to the second portion from the virtual asset storage of the physical property owner to a virtual asset storage of the physical property user.

In Example 2, the subject matter of Example 1 includes, wherein the operations further comprise: determining that a quantity of virtual asset units within the virtual asset storage of the physical property user equals or exceeds the number of virtual asset units corresponding to the value of the physical property; and transferring the digital physical property title for the physical property to the physical property user, the transferring indicating full ownership of the physical property by the physical property user.

In Example 3, the subject matter of Examples 1-2 includes, wherein the operations further comprise: in response to transferring the digital physical property title for the physical property to the physical property user, purging the virtual asset units corresponding to the physical property from a circulating supply of virtual asset units.

In Example 4, the subject matter of Examples 1-3 includes, wherein the operations further comprise: enabling usage of the physical property for the physical property user based on the transfer of the number of digital rights tokens.

In Example 5, the subject matter of Examples 1-4 includes, wherein the operations further comprise: determining a change in the value of the physical property; and modifying the plurality of virtual asset units based on the change in the value of the physical property.

In Example 6, the subject matter of Examples 1-5 includes, wherein the operations further comprise: identifying a change in one or more parameters associated with the physical property that impacts the value of the physical property; upon identifying the change in the one or more parameters, reassessing the value of the physical property; and generating an updated digital physical property title reflecting the reassessment.

In Example 7, the subject matter of Examples 1-6 includes, wherein enabling usage comprises providing the physical property user with access to the physical property by at least one of: generating a unique access code for a digital lock or security system of the physical property, transmitting a signal to one or more Internet of Things (IoT) devices associated with the physical property such that the one or more IoT devices grants access to the physical property user, or automatically booking the physical property for the physical property user for a utilization term for the physical property.

In Example 8, the subject matter of Examples 1-7 includes, wherein the operations further comprise: determining that a quantity of virtual asset units within the virtual asset storage of the physical property user is less than the number of virtual asset units corresponding to the value of the physical property; and recording the digital first physical property title for the first physical property to the first physical property owner.

In Example 9, the subject matter of Examples 1-8 includes, wherein the operations further comprise: recording a lien on the digital physical property title onto a distributed ledger of the blockchain network; and causing execution of a smart contract by broadcasting one or more functions to the blockchain network and receiving validation from the nodes of the blockchain network, the execution of the first smart contract providing the physical property user with access to the physical property.

In Example 10, the subject matter of Examples 1-9 includes, wherein the operations further comprise: recording a lien on the digital physical property title and a record of the virtual asset units transmitted to the virtual asset storage associated with the physical property owner onto a distributed ledger of a blockchain.

In Example 11, the subject matter of Examples 1-10 includes, wherein the operations further comprise: receiving from a physical property intermediary a request to temporarily receive all virtual asset units from current owners of the physical property; and transmitting all virtual asset units from the virtual asset storages that hold the virtual asset units at a time of receiving the request to the virtual asset storage of the physical property intermediary enabling usage rights of the physical property for the physical property intermediary.

In Example 12, the subject matter of Examples 1-11 includes, wherein generating the plurality of virtual asset units comprises initiating generation of the plurality of virtual asset units by a group of nodes of a blockchain, wherein the operations further comprise: initiating recordation of the generation of the plurality of virtual asset units onto a distributed ledger of the blockchain.

In Example 13, the subject matter of Example 12 includes, wherein transferring the digital physical property title comprises initiating the recordation of the ownership of the digital physical property title to the physical property user onto the distributed ledger.

In Example 14, the subject matter of Examples 1-13 includes, wherein the operations further comprise: in response to a lapse of the physical property utilization period for the physical property user, determine whether the quantity of virtual asset units within the virtual asset storage of the physical property user equals or exceeds the number of virtual asset units corresponding to the value of the physical property; and in response to determining that the quantity of virtual asset units within the virtual asset storage of the physical property user does not equal or exceed the number of virtual asset units corresponding to the value of the physical property, renew the physical property utilization period.

In Example 15, the subject matter of Examples 1-14 includes, wherein the physical property includes a collection of physical properties, wherein the physical property user is able to use one of the physical properties, wherein the virtual asset units represent fractional ownership for the collection of the physical properties, wherein the value of the virtual asset units required for the transfer of ownership is the value of the collection of the physical properties.

In Example 16, the subject matter of Examples 1-15 includes, wherein the at least one processor is configured to apply the digital physical property title to a machine learning model, wherein the machine learning performs the operations of identifying the value of the physical property, generating the plurality of virtual asset units corresponding to the value of the physical property, and transmitting the generated virtual asset units to the virtual asset storage associated with the physical property owner.

In Example 17, the subject matter of Examples 1-16 includes, wherein the at least one processor is configured to execute a smart contract causing the blockchain to perform the operations of identifying the value of the physical property, generating the plurality of virtual asset units corresponding to the value of the physical property, and transmitting the generated virtual asset units to the virtual asset storage associated with the physical property owner.

In Example 18, the subject matter of Examples 1-17 includes, wherein the at least one processor is configured to apply the indication of the virtual asset relocation to a machine learning model, wherein the machine learning performs the operations of identifying the first portion of the virtual asset relocation transmitted to the physical property owner, determining the number of virtual asset units corresponding to the second portion of the virtual asset relocation based on the first portion, and transferring the number of virtual asset units corresponding to the second portion from the virtual asset storage of the physical property owner to the virtual asset storage of the physical property user.

Example 19 is a method comprising: receiving a digital physical property title for a physical property from a physical property owner; identifying a value of the physical property; generating a plurality of virtual asset units corresponding to the value of the physical property based on the value and a token value for each digital token, each virtual asset unit representing a fractional ownership interest in the physical property; transmitting the generated virtual asset units to a virtual asset storage associated with the physical property owner; and periodically, during a physical property utilization period for a physical property user: receiving an indication of a virtual asset relocation from the physical property user utilizing the physical property; identifying a first portion of the virtual asset relocation transmitted to the physical property owner; determining a number of virtual asset units corresponding to a second portion of the virtual asset relocation based on the first portion; and transferring the number of virtual asset units corresponding to the second portion from the virtual asset storage of the physical property owner to a virtual asset storage of the physical property user.

Example 20 is a non-transitory computer-readable storage medium storing instructions that, when executed by at least one processor, cause the at least one processor to perform operations comprising: receiving a digital physical property title for a physical property from a physical property owner; identifying a value of the physical property; generating a plurality of virtual asset units corresponding to the value of the physical property based on the value and a token value for each digital token, each virtual asset unit representing a fractional ownership interest in the physical property; transmitting the generated virtual asset units to a virtual asset storage associated with the physical property owner; and periodically, during a physical property utilization period for a physical property user: receiving an indication of a virtual asset relocation from the physical property user utilizing the physical property; identifying a first portion of the virtual asset relocation transmitted to the physical property owner; determining a number of virtual asset units corresponding to a second portion of the virtual asset relocation based on the first portion; and transferring the number of virtual asset units corresponding to the second portion from the virtual asset storage of the physical property owner to a virtual asset storage of the physical property user.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Although examples described herein describe features of the tokenization system using a digitized asset rights document, it is appreciated that the features of the tokenization system can apply to other forms, such as real world property ownership certificate, digital physical property title, digitized asset rights, document, physical asset registry record, physical commodity ownership record document, real estate ownership certificate, real estate possession record, tangible asset ownership record, tangible property conveyance document, deed, title, and/or the like, and/or vice versa.

Although examples described herein describe features of the tokenization system using a real world asset, it is appreciated that the features of the tokenization system can apply to other forms, such as real world property, physical property, tangible property, physical commodity, real estate property, physical asset, real estate, tangible asset, real world asset, and/or the like, and/or vice versa.

Although examples described herein describe features of the tokenization system using an asset holder, it is appreciated that the features of the tokenization system can apply to other forms, such as real world property owner, physical property owner, tangible property owner, physical commodity holder, real estate property proprietor, physical asset possessor, real estate possessor, tangible asset custodian, and/or the like, and/or vice versa.

Although examples described herein describe features of the tokenization system using an asset utilizer, it is appreciated that the features of the tokenization system can apply to other forms, such as real world property user, physical property user, tangible property occupant, physical commodity occupier, real estate property utilizer, physical asset acquirer, real estate user, tangible asset renter, and/or the like, and/or vice versa.

Although examples described herein describe features of the tokenization system using a physical commodity acquirer, it is appreciated that the features of the tokenization system can apply to other forms, such as real estate recipient, tangible asset procurer, and/or the like, and/or vice versa.

Although examples described herein describe features of the tokenization system using a digital tokens, it is appreciated that the features of the tokenization system can apply to other forms, such as digital rights tokens, virtual asset units, electronic ownership tokens, fractionalized property token, digital real estate property token, physical asset digital ledger coins, asset-backed tokens, and/or the like, and/or vice versa.

Although examples described herein describe features of the tokenization system using a digital wallet, it is appreciated that the features of the tokenization system can apply to other forms, such as digital rights token storage, virtual asset storage, electronic token data repository, tokenized account, digital Token repository, digital ledger wallet, digital token storage, virtual token storage, and/or the like, and/or vice versa.

Although examples described herein describe features of the tokenization system using an asset transaction, it is appreciated that the features of the tokenization system can apply to other forms, such as remittance, virtual asset relocation, tokenized exchange, token resource allocation, token provision, digital ledger coin transfer, digital token relocation, token disbursement, asset transaction, digital token relocation, and/or the like, and/or vice versa. Moreover, the tokens in the token disbursement, relocation, remittance, exchange, provisions and/or the like described herein can be different tokens than the tokens that represent usage rights or ownership rights.

Although examples described herein describe features of the tokenization system using an asset utilization period, it is appreciated that the features of the tokenization system can apply to other forms, such as real world property use term, physical property utilization period, occupancy span, tokenized tenure, physical asset use duration, real estate utilization period, and/or the like, and/or vice versa.

### CONCLUSION

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a digital physical property title for a physical property from a physical property owner;
identifying a value of the physical property;
generating a plurality of virtual asset units corresponding to the value of the physical property based on the value and a token value for each digital token, each virtual asset unit representing a fractional ownership interest in the physical property;
transmitting the generated virtual asset units to a virtual asset storage associated with the physical property owner; and
periodically, during a physical property utilization period for a physical property user:
receiving an indication of a virtual asset relocation from the physical property user utilizing the physical property;
identifying a first portion of the virtual asset relocation transmitted to the physical property owner;
determining a number of virtual asset units corresponding to a second portion of the virtual asset relocation based on the first portion; and
transferring the number of virtual asset units corresponding to the second portion from the virtual asset storage of the physical property owner to a virtual asset storage of the physical property user.

2. The system of claim 1, wherein the operations further comprise:
determining that a quantity of virtual asset units within the virtual asset storage of the physical property user equals or exceeds the number of virtual asset units corresponding to the value of the physical property; and
transferring the digital physical property title for the physical property to the physical property user, the transferring indicating full ownership of the physical property by the physical property user.

3. The system of claim 1, wherein the operations further comprise: in response to transferring the digital physical property title for the physical property to the physical property user, purging the virtual asset units corresponding to the physical property from a circulating supply of virtual asset units.

4. The system of claim 1, wherein the operations further comprise: enabling usage of the physical property for the physical property user based on the transfer of the number of virtual asset units.

5. The system of claim 1, wherein the operations further comprise:
determining a change in the value of the physical property; and
modifying the plurality of virtual asset units based on the change in the value of the physical property.

6. The system of claim 1, wherein the operations further comprise:
identifying a change in one or more parameters associated with the physical property that impacts the value of the physical property;
upon identifying the change in the one or more parameters, reassessing the value of the physical property; and
generating an updated digital physical property title reflecting the reassessment.

7. The system of claim 1, wherein enabling usage comprises providing the physical property user with access to the physical property by at least one of: generating a unique access code for a digital lock or security system of the physical property, transmitting a signal to one or more Internet of Things (IoT) devices associated with the physical property such that the one or more IoT devices grants access to the physical property user, or automatically booking the physical property for the physical property user for a utilization term for the physical property.

8. The system of claim 1, wherein the operations further comprise:
determining that a quantity of virtual asset units within the virtual asset storage of the physical property user is less than the number of virtual asset units corresponding to the value of the physical property; and
recording the digital physical property title for the physical property to the physical property owner.

9. The system of claim 1, wherein the operations further comprise:
recording a lien on the digital physical property title onto a distributed ledger of a blockchain network; and causing execution of a smart contract by broadcasting one or more functions to the blockchain network and receiving validation from nodes of the blockchain network, the execution of the smart contract providing the physical property user with access to the physical property.

10. The system of claim 1, wherein the operations further comprise: recording a lien on the digital physical property title and a record of the virtual asset units transmitted to the virtual asset storage associated with the physical property owner onto a distributed ledger of a blockchain.

11. The system of claim 1, wherein the operations further comprise:
receiving from a physical property intermediary a request to temporarily receive all virtual asset units from current owners of the physical property; and
transmitting all virtual asset units from the virtual asset storages that hold the virtual asset units at a time of receiving the request to the virtual asset storage of the physical property intermediary enabling usage rights of the physical property for the physical property intermediary.

12. The system of claim 1, wherein generating the plurality of virtual asset units comprises initiating generation of the plurality of virtual asset units by a group of nodes of a blockchain, wherein the operations further comprise: initiating recordation of the generation of the plurality of virtual asset units onto a distributed ledger of the blockchain.

13. The system of claim 12, wherein transferring the digital physical property title comprises initiating the recordation of the ownership of the digital physical property title to the physical property user onto the distributed ledger.

14. The system of claim 1, wherein the operations further comprise:
in response to a lapse of the physical property utilization period for the physical property user, determine whether the quantity of virtual asset units within the virtual asset storage of the physical property user equals or exceeds the number of virtual asset units corresponding to the value of the physical property; and
in response to determining that the quantity of virtual asset units within the virtual asset storage of the physical property user does not equal or exceed the number of virtual asset units corresponding to the value of the physical property, renew the physical property utilization period.

15. The system of claim 1, wherein the physical property includes a collection of physical properties, wherein the physical property user is able to use one of the physical properties, wherein the virtual asset units represent fractional ownership for the collection of the physical properties, wherein the value of the virtual asset units required for the transfer of ownership is the value of the collection of the physical properties.

16. The system of claim 1, wherein the at least one processor is configured to apply the digital physical property title to a machine learning model, wherein the machine learning performs the operations of identifying the value of the physical property, generating the plurality of virtual asset units corresponding to the value of the physical property, and transmitting the generated virtual asset units to the virtual asset storage associated with the physical property owner.

17. The system of claim 1, wherein the at least one processor is configured to execute a smart contract causing a blockchain to perform the operations of identifying the value of the physical property, generating the plurality of virtual asset units corresponding to the value of the physical property, and transmitting the generated virtual asset units to the virtual asset storage associated with the physical property owner.

18. The system of claim 1, wherein the at least one processor is configured to apply the indication of the virtual asset relocation to a machine learning model, wherein the machine learning performs the operations of identifying the first portion of the virtual asset relocation transmitted to the physical property owner, determining the number of virtual asset units corresponding to the second portion of the virtual asset relocation based on the first portion, and transferring the number of virtual asset units corresponding to the second portion from the virtual asset storage of the physical property owner to the virtual asset storage of the physical property user.

19. A method comprising:
receiving a digital physical property title for a physical property from a physical property owner;
identifying a value of the physical property;
generating a plurality of virtual asset units corresponding to the value of the physical property based on the value and a token value for each digital token, each virtual asset unit representing a fractional ownership interest in the physical property;
transmitting the generated virtual asset units to a virtual asset storage associated with the physical property owner; and
periodically, during a physical property utilization period for a physical property user:
receiving an indication of a virtual asset relocation from the physical property user utilizing the physical property;
identifying a first portion of the virtual asset relocation transmitted to the physical property owner;
determining a number of virtual asset units corresponding to a second portion of the virtual asset relocation based on the first portion; and
transferring the number of virtual asset units corresponding to the second portion from the virtual asset storage of the physical property owner to a virtual asset storage of the physical property user.

20. A non-transitory computer-readable storage medium storing instructions that, when executed by at least one processor, cause the at least one processor to perform operations comprising:
receiving a digital physical property title for a physical property from a physical property owner;
identifying a value of the physical property;
generating a plurality of virtual asset units corresponding to the value of the physical property based on the value and a token value for each digital token, each virtual asset unit representing a fractional ownership interest in the physical property;
transmitting the generated virtual asset units to a virtual asset storage associated with the physical property owner; and
periodically, during a physical property utilization period for a physical property user:
receiving an indication of a virtual asset relocation from the physical property user utilizing the physical property;
identifying a first portion of the virtual asset relocation transmitted to the physical property owner;
determining a number of virtual asset units corresponding to a second portion of the virtual asset relocation based on the first portion; and
transferring the number of virtual asset units corresponding to the second portion from the virtual asset storage of the physical property owner to a virtual asset storage of the physical property user.
